(19) United States
(12) Patent Application Publication
(10) Pub. No.: US 2025/0314386 A1
(43) Pub. Date: Oct. 9, 2025

(54) PORTABLE HOOD AND CONTROL METHOD THEREOF

(71) Applicant: Samsung Electronics Co., Ltd., Suwon-si (KR)

(72) Inventors: Hana CHOI, Suwon-si (KR); Dongjun KIM, Suwon-si (KR); Woojoo KIM, Suwon-si (KR); Juhyun LEE, Suwon-si (KR); Jinho JEONG, Suwon-si (KR); Hyunjoon CHOO, Suwon-si (KR); Jonghun HA, Suwon-si (KR)

(21) Appl. No.: 19/244,353

(22) Filed: Jun. 20, 2025

Related U.S. Application Data
(63) Continuation of application No. PCT/KR2023/017905, filed on Nov. 8, 2023.

(30) Foreign Application Priority Data
Dec. 20, 2022 (KR) 10-2022-0179734

(51) Int. Cl. F24C 15/20; H02J 50/12

(52) U.S. Cl. CPC F24C 15/2078; F24C 15/2021; F24C 15/2035; H02J 50/12

(57) ABSTRACT

A portable range hood and/or a method of controlling the same may be provided. A portable range hood may include: a wireless power receiver, a communication interface; a driving unit; at least one filter; and at least one processor, wherein the at least one processor may be configured to, based on the wireless power receiver being located in a first cooking zone from among the plurality of cooking zones, receive power from the wireless power transmission device, and activate the communication interface, control the communication interface to receive, from the wireless power transmission device, an operation command generated based on state information of the cooking appliance located in a second cooking zone from among the plurality of cooking zones, and control the driving unit to set at least one of whether to perform the draw-in operation, a strength of the draw-in operation, and a duration time of the draw-in operation, based on the operation command.

### CROSS-REFERENCE TO RELATED APPLICATIONS

This application is a continuation application of International Application No. PCT/KR2023/017905 designating the United States, filed on Nov. 8, 2023, in the Korean Intellectual Property Receiving Office and claiming priority to Korean Patent Application No. 10-2022-0179734 filed on Dec. 20, 2022, the disclosures of which are all hereby incorporated by reference herein in their entireties.

### TECHNICAL FIELD

Certain example embodiments may relate to a portable range hood and/or a method of controlling the same.

### BACKGROUND ART

While food is cooked by using a wireless power transmission device such as a gas stove or an induction range, oil vapor and odors may occur. A range hood may be used to remove oil vapor and odors occurring when food is cooked. The range hood may draw in and perform filtering on oil vapor and odorous air, and may discharge air from which oil vapor and odors have been removed. Therefore, the range hood is widely used in cooking food.

An existing range hood is positioned above a gas stove or an induction range, and is fixed at a wall or a ceiling of a kitchen. However, according to kinds of food being cooked, it may be insufficient to remove oil vapor and odors by using only the range hood fixed at the wall or the ceiling of the kitchen. Also, when food is cooked on an island type table apart from the wall of the kitchen, it may be insufficient to remove oil vapor and odors by using only the range hood fixed at the wall or the ceiling of the kitchen.

In a case of an existing range hood combined induction range, an air path via which a range hood draws in air is placed on the lower part, it may be insufficient to remove oil vapor and odors. In a case of a range hood combined induction range, an area of a burner of the induction range may be decreased.

An existing wired range hood may be used only at a position close to a socket, there may be restrictions on usage places and directions. Also, a user has to directly input all operations with respect to the wired range hood, the user may experience inconvenience.

### SUMMARY

According to an example embodiment, a portable range hood may include a wireless power receiver configured to receive power from a wireless power transmission device including a plurality of cooking zones, a communication interface, comprising interface circuitry, configured to establish wireless communication connection to the wireless power transmission device or a cooking appliance placed on the wireless power transmission device, a driving unit, comprising a motor and/or a fan, configured to receive the power and perform a draw-in operation for drawing in air into the portable range hood, at least one filter configured to filter out oil vapor and odors included in the air, and at least one processor comprising processing circuitry. According to an example embodiment, the at least one processor may be individualy and/or collectively configured to, based on the wireless power receiver being located in a first cooking zone from among the plurality of cooking zones, receive power from the wireless power transmission device, and activate the communication interface, control the communication interface to receive, from the wireless power transmission device, an operation command generated based on state information of the cooking appliance located in a second cooking zone from among the plurality of cooking zones, and control the driving unit to set at least one of whether to perform the draw-in operation, a strength of the draw-in operation, and a duration time of the draw-in operation, based on the operation command.

According to an example embodiment, a method of controlling a portable range hood may include, based on a wireless power receiver of the portable range hood being located in a first cooking zone from among a plurality of cooking zones included in a wireless power transmission device, receiving power from the wireless power transmission device, and activating a communication interface of the portable range hood, receiving, from the wireless power transmission device, an operation command generated based on state information of a cooking appliance located in a second cooking zone from among the plurality of cooking zones; and setting, based on the operation command, at least one of whether to perform a draw-in operation for drawing in air into the portable range hood, a strength of the draw-in operation, and a duration time of the draw-in operation.

According to an example embodiment, a wireless power transmission device may include a plurality of cooking zones, a wireless power transmitter, a communication interface comprising circuitry, and at least one processor comprising processing circuitry. According to an example embodiment, the at least one processor may be configured to establish wireless communication connection by transmitting power to a portable range hood located in a first cooking zone from among the plurality of cooking zones, control the communication interface to receive state information of a cooking appliance located in a second cooking zone from among the plurality of cooking zones, generate an operation command, based on the state information, and control the communication interface to transmit the operation command to the portable range hood.

### BRIEF DESCRIPTION OF DRAWINGS

FIG. 1 is a diagram illustrating a system including a portable range hood according to an example embodiment.

FIG. 2 is a block diagram illustrating a wireless power transmission device according to an example embodiment.

FIG. 3 is a diagram illustrating a cooking appliance according to an example embodiment.

FIG. 4 is a diagram illustrating a cooking appliance according to an example embodiment.

FIG. 5 is a block diagram illustrating a portable range hood according to an example embodiment.

FIG. 6 is a block diagram illustrating a portable range hood according to an example embodiment.

FIG. 7 is a block diagram illustrating a portable range hood according to an example embodiment.

FIG. 8 is a diagram illustrating that a wireless power transmission device transmits power according to an example embodiment.

FIG. 9 is a diagram illustrating that a wireless power transmission device transmits power according to an example embodiment.

FIG. 10 is a diagram illustrating air being flown into and exhausted from a portable range hood according to an example embodiment.

FIG. 11 is a flowchart illustrating a communication connection method by a portable range hood according to an example embodiment.

FIG. 12 is a flowchart illustrating an exhaust control method by a portable range hood according to an example embodiment.

FIG. 13A is a flowchart illustrating an exhaust control method by a portable range hood according to an example embodiment.

FIG. 13B is a flowchart illustrating an exhaust control method by a portable range hood according to an example embodiment.

FIG. 14 is a flowchart illustrating a method of setting a draw-in direction and a draw-in height of a portable range hood according to an example embodiment.

FIG. 15 is a diagram illustrating that a portable range hood sets a draw-in direction and a draw-in height, according to an example embodiment.

FIG. 16 is a flowchart illustrating a draw-in operation control method of a portable range hood according to an example embodiment.

FIG. 17 is a diagram illustrating that a portable range hood controls a draw-in operation according to an example embodiment.

FIG. 18 is a flowchart illustrating that a portable range hood operates in a different mode, according to opening and closing of a lid of a cooking appliance, according to an example embodiment.

FIG. 19A is a flowchart illustrating that a portable range hood operates based on operation information of a fixed range hood, according to an example embodiment.

FIG. 19B is a flowchart illustrating that a portable range hood operates based on operation information of a fixed range hood, according to an example embodiment.

FIG. 20 is a flowchart illustrating that a portable range hood operates based on operation information of a fixed range hood, according to an example embodiment.

FIG. 21 is a diagram illustrating an example in which a portable range hood operates based on operation information of a fixed range hood, according to an example embodiment.

FIG. 22 is a flowchart illustrating that a wireless power transmission device outputs a cleaning request notification with respect to a portable range hood, according to an example embodiment.

FIG. 23 illustrates an example in which a wireless power transmission device outputs a cleaning request notification with respect to a portable range hood, according to an example embodiment.

FIG. 24 is a flowchart illustrating that a user terminal outputs a cleaning request notification with respect to a portable range hood, according to an example embodiment.

FIG. 25 is a diagram illustrating a system including a user terminal according to an example embodiment.

FIG. 26 illustrates an example in which a user terminal outputs a cleaning request notification with respect to a portable range hood, according to an example embodiment.

FIG. 27 is a flowchart illustrating a process of detaching and cleaning a portable range hood, according to an example embodiment.

FIG. 28 is a diagram illustrating a wireless power transmission device according to an example embodiment.

FIG. 29 is a diagram illustrating a cooking appliance according to an example embodiment.

FIG. 30 is a diagram illustrating a cooking appliance according to an example embodiment.

FIG. 31 is a diagram illustrating a cooking appliance according to an example embodiment.

### DETAILED DESCRIPTION

The terms used in the present disclosure will be briefly defined, and an example embodiment will be described in detail.

Although the terms used in the present disclosure are selected from among common terms that are currently widely used in consideration of their functions in an example embodiment, the terms may vary according the intention of one of ordinary skill in the art, a precedent, or the advent of new technology. Also, in particular cases, the terms are discretionally selected by the applicant, and the meaning of those terms will be described in detail in the corresponding part of the detailed description of an example embodiment. Therefore, the terms used in the present disclosure are not merely designations of the terms, but the terms are defined based on the meaning of the terms and content throughout the disclosure.

Throughout the present disclosure, the expression “at least one of a, b or c” indicates “only a,” “only b,” “only c,” “both a and b,” “both a and c”, “both b and c,” “all of a, b, and c,” or variations thereof.

Throughout the present disclosure, when a part “includes” or “comprises” an element, it means that the part may additionally include or comprise other elements rather than excluding other elements as long as there is no particular opposing recitation. In addition, as used in the present specification, terms such as “ . . . unit”, “ . . . module”, etc., indicate a unit that performs at least one function or operation, which may be implemented as hardware or software or a combination thereof.

Hereinafter, an example embodiment will be described in detail with reference to the accompanying drawings to allow one of skill in the art to easily implement the embodiment. However, an example embodiment may be embodied in many different forms and should not be construed as being limited to an embodiment set forth herein. In addition, in the drawings, parts irrelevant to the description are omitted to clearly describe an example embodiment, and like elements are denoted by like reference numerals throughout the present disclosure.

The present disclosure provides a portable range hood configured to perform a draw-in operation, based on state information of a cooking appliance located on a wireless power transmission device, and a control method.

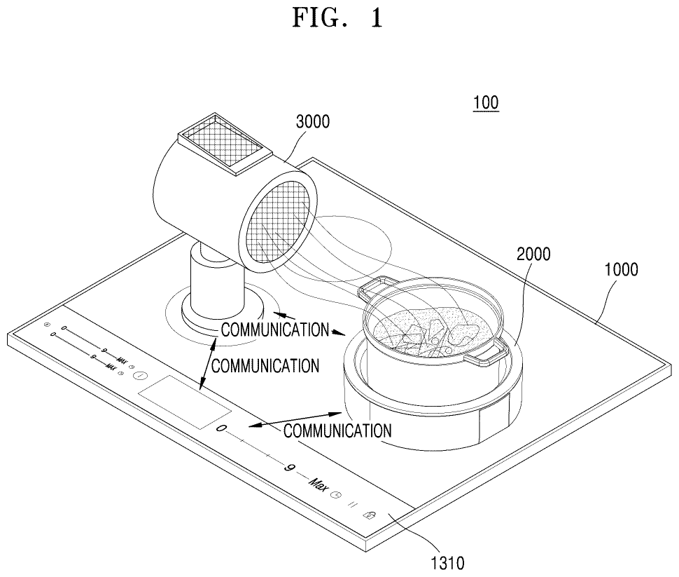

FIG. 1 is a diagram illustrating a system including a portable range hood according to an example embodiment.

Referring to FIG. 1, a system 100 according to an example embodiment may include a wireless power transmission device 1000, a cooking appliance 2000, and a portable range hood 3000. However, not all the elements shown in FIG. 1 are necessary elements. The system 100 may be implemented by more elements than the elements shown in FIG. 1, or may be implemented by fewer elements. For example, the system 100 may be implemented with the wireless power transmission device 1000, the cooking appliance 2000, the portable range hood 3000, and a server device (not shown). Hereinafter, each configuration of the system 100 will now be described.

According to an example embodiment, the wireless power transmission device 1000 may be a device that wirelessly transmits power to at least one of the cooking appliance 2000 and the portable range hood 3000 located on a top plate, by using electromagnetic induction. The wireless power transmission device 1000 may also be expressed as an induction heating apparatus, an induction range, a cooktop, or an electric range. For example, the wireless power transmission device 1000 may be a heating appliance for cooking that is collectively referred to as an induction range or induction which uses the principle of induction heating. The wireless power transmission device 1000 may include a working coil that generates a magnetic field for inductively heating the cooking appliance 2000. The working coil may be collectively referred to as a transmission coil. The wireless power transmission device 1000 may wirelessly transmit power to the portable range hood 3000 by using the working coil.

In order to wirelessly transmit power, the wireless power transmission device 1000 may transmit power by using a magnetic field induced in a reception coil or an induction-heating (IH) metal (e.g., an iron component) in a magnetic induction method. For example, the wireless power transmission device 1000 may cause a current to flow in the working coil to form a magnetic field, and thus may generate an eddy current in the cooking appliance 2000 or induce a magnetic field in the reception coil of the cooking appliance 2000. For example, the wireless power transmission device 1000 may cause a current to flow in the working coil to form a magnetic field, and thus, may allow a magnetic field to be induced in a wireless power receiver of the portable range hood 3000.

According to an example embodiment, the wireless power transmission device 1000 may include a plurality of working coils. For example, when the top plate of the wireless power transmission device 1000 includes a plurality of cooking zones (also referred to as burners), the wireless power transmission device 1000 may include a plurality of working coils respectively corresponding to the plurality of cooking zones. Also, the wireless power transmission device 1000 may include a high-power cooking zone in which a first working coil is provided inside thereof and a second working coil is provided outside thereof. The high-power cooking zone may include three or more working coils.

According to an example embodiment, the top plate of the wireless power transmission device 1000 may include tempered glass, such as ceramic glass, such that the top plate is not easily damaged. Also, a guide mark may be provided on the top plate of the wireless power transmission device 1000 so as to guide a cooking zone in which at least one of the cooking appliance 2000 and the portable range hood 3000 needs to be located.

According to an example embodiment, the wireless power transmission device 1000 may detect that at least one of the cooking appliance 2000 (e.g., a general IH container, an IH cooking appliance) including the magnetic material and the portable range hood 3000 is placed on the top plate. For example, based on a change in a current value (inductance) of the working coil due to approach of the cooking appliance 2000, the wireless power transmission device 1000 may detect that the cooking appliance 2000 is located on the top plate of the wireless power transmission device 1000. For example, the wireless power transmission device 1000 may establish wireless communication connection to the portable range hood 3000, and may detect the cooking appliance 2000 is located on the top plate of the wireless power transmission device 1000. Hereinafter, a mode in which the wireless power transmission device 1000 detects the cooking appliance 2000 including the magnetic material (IH metal) is defined as an “IH container detection mode (pan detection mode)”.

According to an example embodiment, the wireless power transmission device 1000 may include a communication interface for communicating with an external apparatus. For example, the wireless power transmission device 1000 may communicate with the cooking appliance 2000, the portable range hood 3000, or the server device via the communication interface. The communication interface may include a short-range wireless communication interface (e.g., an NFC communication interface, a Bluetooth communication interface, a Bluetooth low energy (BLE) communication interface, etc.), a long-range wireless communication interface, etc. The wireless power transmission device 1000 may be connected to the cooking appliance 2000, the portable range hood 3000, a mobile terminal, or the server device via a network. The network may include a local area network (LAN) established around a wide area network (WAN) such as Internet, and an access point (AP), and a wireless personal area network (WPAN) without accessing the AP. The WPAN may include Bluetooth™ (IEEE 802.15.1), Zigbee (IEEE 802.15.4), Wi-Fi Direct, near field communication (NFC), Z-Wave, etc. but the present disclosure is not limited thereto.

According to an example embodiment, the wireless power transmission device 1000 may detect the cooking appliance 2000 or the portable range hood 3000 located on the top plate via the communication interface. For example, the wireless power transmission device 1000 may detect the cooking appliance 2000 by receiving a packet transmitted from the cooking appliance 2000 located on the top plate, by using short-range wireless communication (e.g., BLE or Bluetooth). For example, the wireless power transmission device 1000 may detect the portable range hood 3000 by receiving a packet transmitted from the portable range hood 3000 located on the top plate by using short-range wireless communication (e.g., BLE or Bluetooth). As the cooking appliance 2000 including the communication interface may be defined as a small appliance (small object), hereinafter, a mode in which the wireless power transmission device 1000 detects the cooking appliance 2000 via the communication interface is defined as a “small appliance detection mode”. The wireless power transmission device 1000 may transmit power for activating the communication interface of the cooking appliance 2000 via the plurality of cooking zones in the small appliance detection mode.

According to an example embodiment, the wireless power transmission device 1000 may receive, from the cooking appliance 2000, the unique identification information (e.g., a MAC address) and the variable identification information of the cooking appliance 2000 via short-range wireless communication (e.g., BLE communication or Bluetooth communication) in the small appliance detection mode. In this regard, when the variable identification information of the cooking appliance 2000 includes information indicating that a current location is unknown, the wireless power transmission device 1000 outputs power according to different power transmission patterns for respective cooking zones, thereby allowing the cooking appliance 2000 to recognize a current location. Hereinafter, a mode in which the wireless power transmission device 1000 outputs power according to different power transmission patterns for the respective cooking zones may be defined as a ‘cooking zone determination mode’. When the wireless power transmission device 1000 operates in the cooking zone determination mode, the wireless power transmission device 1000 may receive information of a first cooking zone corresponding to a first power transmission pattern detected by the cooking appliance 2000 and variable identification information including product type information (e.g., a product type image, a product type text) of the cooking appliance 2000. In this case, the first cooking zone may be a cooking zone in which the cooking appliance 2000 is located, from among the plurality of cooking zones included in the wireless power transmission device 1000. The product type information of the cooking appliance 2000 may be information indicating a product type of the cooking appliance 2000, and the product type may include a smart pot, a smart kettle, a coffee maker, a toaster, a blender, etc., but the present disclosure is not limited thereto.

When the wireless power transmission device 1000 receives the variable identification information including the location information of the cooking appliance 2000 and the product type information of the cooking appliance 2000, the wireless power transmission device 1000 may display the location information of the cooking appliance 2000 and the product type information of the cooking appliance 2000 on an output interface, based on the variable identification information. For example, the wireless power transmission device 1000 may display, on the output interface, an icon indicating the cooking appliance 2000 at a position corresponding to a cooking zone, and thus, may provide a user with the product type information (e.g., kettle) of the cooking appliance 2000 and the location information (e.g., located in the right cooking zone) of the cooking appliance 2000. The user may identify the type and the location of the cooking appliance 2000 via the output interface, and may input an operation to be performed by the wireless power transmission device 1000. For example, the user may input a heat-up request for the wireless power transmission device 1000 to heat up contents in the cooking appliance 2000. The wireless power transmission device 1000 may wirelessly supply power corresponding to a heat-up operation to the cooking appliance 2000, thereby heating up contents in the cooking appliance 2000.

The cooking appliance 2000 may be a device for heating up contents. The contents may include liquids, such as water, tea, coffee, soup, juice, wine, and oil, or may include solids, such as butter, meat, vegetables, bread, and rice, but the present disclosure is not limited thereto.

According to an example embodiment, the cooking appliance 2000 may wirelessly receive power from the wireless power transmission device 1000 by using electromagnetic induction. Therefore, according to an example embodiment, the cooking appliance 2000 may not include a power line connected to a power outlet.

According to an example embodiment, there may be various types of the cooking appliance 2000 that wirelessly receives power from the wireless power transmission device 1000. The cooking appliance 2000 may include a general IH container including a magnetic material, or may include the cooking appliance 2000 including a communication interface. Hereinafter, the cooking appliance 2000 including the communication interface may be defined as a small appliance. According to an example embodiment, the cooking appliance 2000 may include an induction heating load device 2000-1 including a magnetic material (IH metal) (e.g., an iron component), and an induced voltage load device 2000-2 including a reception coil. In the induction heating load device 2000-1, a magnetic field may be induced in a container (IH metal) itself. In the induced voltage load device 2000-2, a magnetic field may be induced in the reception coil.

The cooking appliance 2000 may include a general IH container, such as a pot, a frying pan, and a steamer, or may include a small appliance, such as an electric kettle, a teapot, a coffee maker (or coffee dripper), a toaster, a blender, an electric rice cooker, an oven, and an air fryer, but the present disclosure is not limited thereto. The cooking appliance 2000 may include a cooker device. The cooker device may be a device into or from which a general IH container may be inserted or detached. According to an embodiment, the cooker device may be a device capable of automatically cooking contents according to a recipe. The cooker device may also be referred to as a pot, a rice cooker, or a steamer depending on an intended use thereof. For example, when an inner pot capable of cooking rice is inserted into the cooker device, the cooker device may be referred to as a rice cooker. Hereinafter, the cooker device may be defined as a smart pot.

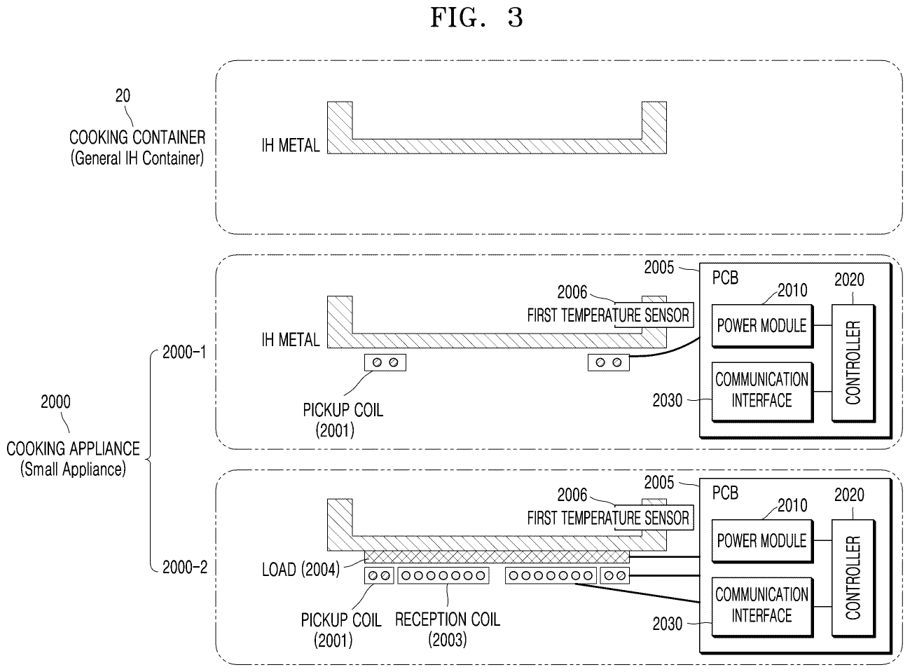

Types of the cooking appliance 2000 will be described in detail with reference to FIGS. 3, 4, and 29 to 31.

According to an example embodiment, the portable range hood 3000 may be located in the first cooking zone from among the plurality of cooking zones of the top plate of the wireless power transmission device 1000. The portable range hood 3000 may activate a communication interface by using power received from the wireless power transmission device 1000. The portable range hood 3000 may operate by using power received from the wireless power transmission device 1000.

According to an example embodiment, the portable range hood 3000 may remove oil vapor and odors which occur as food in the cooking appliance 2000 placed on the wireless power transmission device 1000 is cooked. The portable range hood 3000 may draw in oil vapor and odorous air which occur in the cooking appliance 2000. The portable range hood 3000 may remove oil vapor and odors by filtering drawn-in air. The portable range hood 3000 may discharge air from which oil vapor and odors have been removed. The portable range hood 3000 may establish wireless communication connection with the wireless power transmission device 1000 or the cooking appliance 2000. The portable range hood 3000 may perform a draw-in operation based on received information and command.

According to an example embodiment, the cooking appliance 2000 The cooking appliance 2000 may transmit state information of the cooking appliance 2000 to the wireless power transmission device 1000 via the communication interface. For example, the cooking appliance 2000 may transmit unique identification information and variable identification of the cooking appliance 2000 to the wireless power transmission device 1000. The unique identification information of the cooking appliance 2000 is unique information for identifying the cooking appliance 2000, and may include at least one of a MAC address, a model type, device type information (e.g., an IH type ID, a heater type ID, a motor type ID, or a small appliance type ID), manufacturer information (e.g., manufacturer ID), a serial number, and manufacture time information (year/month/day of the manufacture), but the present disclosure is not limited thereto. According to an example embodiment, the unique identification information of the cooking appliance 2000 may be expressed as identification numbers or a combination of numbers and alphabet letters. The variable identification information of the cooking appliance 2000 is information that varies according to a state of the cooking appliance 2000, and for example, may include information indicating a registration state of the cooking appliance 2000, location information of the cooking appliance 2000, product type information of the cooking appliance 2000, but the present disclosure is not limited thereto. The location information of the cooking appliance 2000 may include information of the cooking zone in which the cooking appliance 2000 is located. According to an example embodiment, the variable identification information of the cooking appliance 2000 may be expressed as identification numbers or a combination of numbers and alphabet letters. The variable identification information of the cooking appliance 2000 may be included in the form of a universally unique identifier (UUID) in an advertising packet.

According to an example embodiment, the wireless power transmission device 1000 may generate an operation command based on the state information of the cooking appliance 2000. The operation command may be a command for controlling a draw-in operation of the portable range hood 3000. For example, the operation command may include a command for determining whether to perform the draw-in operation as to whether it is a situation that the portable range hood 3000 has to perform the draw-in operation. For example, the operation command may include a command for setting a strength of the draw-in operation of the portable range hood 3000. For example, the operation command may include a command for setting a duration time of the draw-in operation of the portable range hood 3000. The wireless power transmission device 1000 may transmit the operation command to the portable range hood.

According to an example embodiment, the portable range hood 3000 may receive the operation command from the wireless power transmission device 1000. The portable range hood 3000 may set at least one of whether to perform the draw-in operation, a strength of the draw-in operation, and a duration time of the draw-in operation, based on the operation command. In this manner, as the portable range hood 3000 located in the first cooking zone performs the draw-in operation, oil vapor and odors which occur from the cooking appliance 2000 located in a second cooking zone may be efficiently removed. Also, as the portable range hood 3000 performs the draw-in operation according to the operation command based on the state information of the cooking appliance 2000, oil vapor and odors which occur from the cooking appliance 2000 may be efficiently removed by reflecting a state of the cooking appliance 2000.

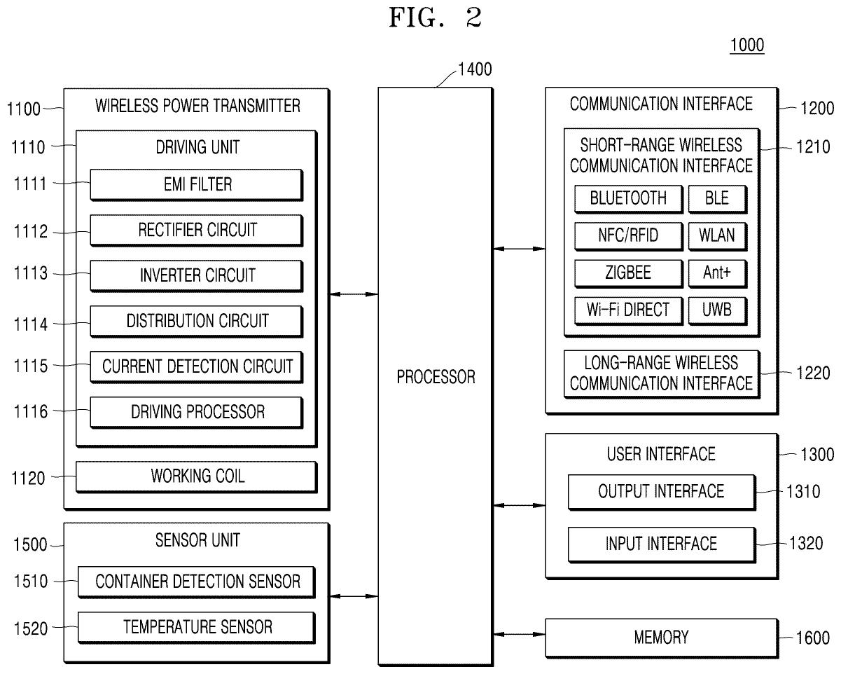

Hereinafter, elements included in the wireless power transmission device 1000 will now be described with reference to FIG. 2.

FIG. 2 is a block diagram illustrating the wireless power transmission device 1000 according to an example embodiment. According to an example embodiment, the wireless power transmission device 1000 may include a wireless power transmitter 1100, a communication interface 1200, a user interface 1300, a processor 1400, a sensor unit 1500, and a memory 1600.

The wireless power transmitter 1100 may wirelessly transmit power. The wireless power transmitter 1100 may receive power from an external source. The wireless power transmitter 1100 may wirelessly transmit power, according to a driving control signal of the processor 1400 comprising processing circuitry.

The wireless power transmitter 1100 may include a driving unit 1110 and a working coil 1120. The driving unit 1110 may receive power from the external source, and may supply a current to the working coil 1120 according to the driving control signal of the processor 1400. The working coil 1120 may wirelessly transmit power to the cooking appliance 2000. The driving unit 1110 may include an electromagnetic interference (EMI) filter 1111, a rectifier circuit 1112, an inverter circuit 1113, a distribution circuit 1114, a current detection circuit 1115, and a driving processor 1116.

The EMI filter 1111 may block high-frequency noise included in alternating current (AC) power supplied from the external source. The EMI filter 1111 may transmit an AC voltage and an AC current of a predetermined frequency (e.g., 50 Hz or 60 Hz). A fuse and a relay may be provided between the EMI filter 1111 and the external source so as to block overcurrent. AC power of which high-frequency noise has been blocked by the EMI filer 1111 may be supplied to the rectifier circuit 1112.

The rectifier circuit 1112 may convert the AC power to DC power. For example, the rectifier circuit 1112 may convert an AC voltage whose a magnitude and a polarity (positive voltage or negative voltage) change over time into a DC voltage whose a magnitude and a polarity are constant, and may convert an AC current whose a magnitude and a polarity (positive current or negative current) change over time to a direct current (DC) current having a constant magnitude. The rectifier circuit 1112 may include a bridge diode. For example, the rectifier circuit 1112 may include the bridge diode consisting of four diodes. The bridge diode may convert an AC voltage whose polarity changes over time to a positive voltage whose polarity is constant, and may convert an AC current whose direction changes over time to a positive current whose direction is constant. The rectifier circuit 1112 may include a DC link capacitor. The DC link capacitor may convert a positive voltage whose magnitude changes over time to a DC voltage having a constant magnitude.

The inverter circuit 1113 may include a switching circuit that supplies or blocks a driving current to or from the working coil 1120, and a resonance circuit that causes resonance together with the working coil 1120. The switching circuit may include a first switch and a second switch. The first switch and the second switch may be connected in series between a plus line and a minus line output by the rectifier circuit 1112. The first switch and the second switch may be turned on or off according to a driving control signal of the driving processor 1116. “Connected” as used herein covers both direct and indirect connections.

The inverter circuit 1113 may control a current that is supplied to the working coil 1120. For example, the magnitude and direction of the current flowing in the working coil 1120 may change according to turning on/off of the first switch and the second switch included in the inverter circuit 1113. In this case, an AC current may be supplied to the working coil 1120. An AC current in the form of a sine wave is supplied to the working coil 1120 according to switching operations of the first switch and the second switch. The longer respective switching periods of the first switch and the second switch (e.g., the smaller respective switching frequencies of the first switch and the second switch are), the larger the current supplied to the working coil 1120 may be, and the larger the intensity of a magnetic field output by the working coil 1120 (output of the wireless power transmission device 1000) may be.

According to an embodiment, when the wireless power transmission device 1000 includes a plurality of working coils 1120, the driving unit 1110 may include the distribution circuit 1114. The distribution circuit 1114 may include a plurality of switches that pass or block a current supplied to the plurality of working coils 1120. Each of the plurality of switches included in the distribution circuit 1114 may be turned on or off, in response to a distribution control signal of the driving processor 1116.

The current detection circuit 1115 may include a current sensor configured to measure the current output from the inverter circuit 1113. The current sensor may transmit an electrical signal corresponding to a value of the measured current to the driving processor 1116.

The driving processor 1116, comprising processing circuitry, may determine a switching frequency (turn-on frequency/turn-off frequency) of the switching circuit included in the inverter circuit 1113, based on the output intensity (power level) of the wireless power transmission device 1000. The driving processor 1116 may generate a driving control signal for turning on/off the switching circuit according to the determined switching frequency.

According to an example embodiment, the wireless power transmitter 1100 may wirelessly transmit power to the cooking appliance 2000 and the portable range hood 3000. For example, the wireless power transmitter 1100 may wirelessly transmit, by using the working coil 1120, power to the cooking appliance 2000 and the portable range hood 3000 located in a cooking zone. The wireless power transmitter 1100 may generate a magnetic field for heating up the cooking appliance 2000 or transmitting power to the portable range hood 3000. For example, when a driving current is supplied to the working coil 1120 of the wireless power transmitter 1100, a magnetic field may be induced around the working coil 1120. When a current whose magnitude and direction change over time, that is, an AC current, is supplied to the working coil 1120, a magnetic field whose magnitude and direction change over time may be induced around the working coil 1120. The magnetic field around the working coil 1120 may pass through a top plate including tempered glass. The magnetic field around the working coil 1120 may reach the cooking appliance 2000 placed on the top plate of the wireless power transmission device 1000. Due to the magnetic field whose magnitude and direction change over time, an eddy current rotating about the magnetic field may occur in the cooking appliance 2000. Electrical resistance heat may be generated in the cooking appliance 2000 due to the eddy current occurring in the cooking appliance 2000. The electrical resistance heat is heat generated in a resistor when a current flows in the resistor, and is referred to as Joule heat. While the cooking appliance 2000 is being heated by the electric resistance heat, contents in the cooking appliance 2000 may be heated. When the cooking appliance 2000 is the induced voltage load device 2000-2 including a reception coil, the magnetic field around the working coil 1120 may be induced in the reception coil of the cooking appliance 2000. Also, due to the magnetic field, a wireless power receiver of the portable range hood 3000 may receive power. When the wireless power receiver of the portable range hood 3000 includes a reception coil, the magnetic field around the working coil 1120 may be induced in the reception coil of the wireless power receiver of the portable range hood 3000.

The communication interface 1200 may establish a wireless communication connection with the cooking appliance 2000 and the portable range hood 3000. The communication interface 1200 may include one or more elements for establishing the wireless communication connection with the cooking appliance 2000 and the portable range hood 3000. The communication interface 1200 may include a short-range wireless communication interface 1210 and a long-range wireless communication interface 1220.

The short-range wireless communication interface 1210 may include a Bluetooth communication interface, a BLE communication interface, an NFC interface, a WLAN (Wi-Fi) communication interface, a Zigbee communication interface, an infrared data association (IrDA) communication interface, a Wi-Fi Direct (WFD) communication interface, an ultra-wideband (UWB) communication interface, an Ant+ communication interface, etc., but the present disclosure is not limited thereto.

When the cooking appliance 2000 and the portable range hood 3000 are remotely controlled by the server device (not shown) in an Internet of Things (IoT) environment, the long-range wireless communication interface 1220 may be used to communicate with the server device. The long-range wireless communication interface 1220 may include the Internet, a computer network (e.g., a LAN or a WAN), a mobile communication interface, etc. The mobile communication interface transmits and receives wireless signals to and from at least one of a base station, an external device, or a server in a mobile communication network. Herein, the wireless signals may include various types of data based on transmission and reception of voice call signals, video call signals, or text/multimedia messages. The mobile communication interface may include a 3^{rd}-generation (3G) module, a 4^{th}-generation (4G) module, a Long Term Evolution (LTE) module, a 5^{th}-generation (5G) module, a 6^{th}-generation (6G) module, a narrowband Internet of Things (NB-IoT) module, an LTE for machines (LTE-M) module, etc., but the present disclosure is not limited thereto.

The user interface 1300 may include an output interface 1310 and an input interface 1320. The output interface 1310 may include a display unit and a sound output unit.

The display unit may visually display information about the cooking appliance 2000 and the portable range hood 3000. For example, the display unit may output a graphical user interface (GUI) corresponding to the identification information or the product type information of the cooking appliance 2000. For example, the display unit may output information about current locations of the cooking appliance 2000 and the portable range hood 3000. For example, the display unit may output information about a draw-in operation state of the portable range hood 3000. The sound output unit may output audio data received via the communication interface 1200 or stored in the memory 1600. For example, the sound output unit may output an audio signal related to a function performed by the wireless power transmission device 1000. For example, the sound output unit may output an audio guidance about a draw-in state of the portable range hood 3000. For example, when information about a cooking zone in which the cooking appliance 2000 or the portable range hood 3000 is located is not received within a preset time, the output interface 1310 may display a notification or output a voice indicating to check a location of the cooking appliance 2000 or the portable range hood 3000.

The input interface 1320 is arranged to receive an input from a user. For example, the input interface 1320 may include at least one of a key pad, a dome switch, a touch pad (using a touch capacitance method, a pressure-resistive layer method, an infrared sensing method, a surface ultrasonic conductive method, an integral tension measuring method, a piezo effect method, etc.), a jog wheel, and a jog switch, but the present disclosure is not limited thereto.

The input interface 1320 may include a speech recognition module. For example, the wireless power transmission device 1000 may receive a speech signal, which is an analog signal, via a microphone and may convert a speech part into computer-readable text by using an automatic speech recognition (ASR) model. The wireless power transmission device 1000 may obtain a user's intention to speak by interpreting the converted text using a natural language understanding (NLU) model. In this case, the ASR model or the NLU model may be an artificial intelligence (AI) model. The AI model may be processed by an AI-only processor that is designed in a hardware structure specialized for processing the AI model. The AI model may be created through learning. Generating the AI model through learning means that a basic AI model is trained using a plurality of pieces of training data by a learning algorithm such that a predefined operation rule or AI model set to perform a desired characteristic (or purpose) is created. The AI model may include a plurality of neural network layers. Each of the plurality of neural network layers has a plurality of weight values, and may perform a neural network operation through an operation between an operation result of a previous layer and the plurality of weight values. Linguistic understanding is a technique that identifies and applies/processes human language/characters, and includes natural language processing, machine translation, a dialog system, question answering, speech recognition/synthesis, etc.

The processor 1400, comprising processing circuitry, may control all operations of the wireless power transmission device 1000. The processor 1400 may execute programs stored in the memory 1600 so as to control the wireless power transmitter 1100 and the communication interface 1200. The processor 1400 may be an AI processor. The AI processor may be manufactured in the form of a dedicated hardware chip for AI, or may be manufactured as a part of an existing general-purpose processor (for example, a central processing unit (CPU) or an application processor (AP)) or a graphic-dedicated processor (for example, a GPU) and may be mounted on, directly or indirectly, the wireless power transmission device 1000.

According to an example embodiment, the processor 1400 may control the wireless power transmitter 1100 to supply power of a preset level to the cooking appliance 2000 and the portable range hood 3000 to drive the communication interface of the cooking appliance 2000 and the communication interface of the portable range hood 3000. When the communication interface of the cooking appliance 2000 is driven, the processor 1400 may receive a first wireless communication signal transmitted from the communication interface of the cooking appliance 2000. The first wireless communication signal may include identification information (e.g., a

MAC address) of the cooking appliance 2000 and information about a second cooking zone in which the cooking appliance 2000 is located, but the present disclosure is not limited thereto. When the communication interface of the portable range hood 3000 is driven, the processor 1400 may receive a second wireless communication signal transmitted from the communication interface of the portable range hood 3000. The second wireless communication signal may include identification information of the portable range hood 3000 or information about a first cooking zone in which the portable range hood 3000 is located, but the present disclosure is not limited thereto.

According to an example embodiment, when the processor 1400 detects the first wireless communication signal transmitted from the cooking appliance 2000 and the second wireless communication signal transmitted from the portable range hood 3000, the processor 1400 may control the wireless power transmitter 1100 to drive the plurality of working coils 1120 to generate a magnetic field according to a plurality of different power transmission patterns. The plurality of power transmission patterns may be set differently based on at least one of a duration time of a power transmission section, a duration time of a power-suspension section, a power level, and an operating frequency. For example, the processor 1400 may control the wireless power transmitter 1100 to transmit power by differently combining the duration time of the power transmission section, the duration time of the power-suspension section, or the power level (operating frequency) for each cooking zone.

According to an example embodiment, the processor 1400 may receive response signals respectively corresponding to power transmission patterns which are from among the plurality of power transmission patterns and are detected at locations of the cooking appliance 2000 and the portable range hood 3000, from the cooking appliance 2000 and the portable range hood 3000 via the communication interface 1200. The response signals may include information about cooking zones in which the cooking appliance 2000 and the portable range hood 3000 are located, respectively, and identification information (or product type information). The processor 1400 may control the communication interface 1200 to receive state information of the cooking appliance 2000 from the cooking appliance 2000. The state information may include at least one of location information of a second cooking zone in which the cooking appliance 2000 is placed, temperature information of the cooking appliance 2000 or the second cooking zone, and height information of the cooking appliance 2000.

According to an example embodiment, the processor 1400 may control the wireless power transmitter 1100 to transmit, to each of the cooking appliance 2000 and the portable range hood 3000, power of a first level (low power) for maintaining the communication connection with the cooking appliance 2000 and the portable range hood 3000. The processor 1400 may control the wireless power transmitter 1100 to transmit, to the cooking appliance 2000 and the portable range hood 3000, power of a second level (high power) for heating up the cooking appliance 2000. The power of the first level is less than the power of the second level.

The processor 1400 may generate an operation command, based on the state information received from the cooking appliance 2000. The operation command may be a command for overall controlling the draw-in operation of the portable range hood 3000. The operation command may set at least one of whether the portable range hood 3000 performs the draw-in operation, a strength of the draw-in operation, and a duration time of the draw-in operation. The processor 1400 may control the communication interface 1200 to transmit the operation command to the portable range hood 3000.

The sensor unit 1500 may include a container detection sensor 1510 and a temperature sensor 1520, but the present disclosure is not limited thereto.

The container detection sensor 1510 may be a sensor configured to detect that the cooking appliance 2000 is placed on the top plate of the wireless power transmission device 1000. For example, the container detection sensor 1510 may be implemented as a current sensor, but the present disclosure is not limited thereto. The container detection sensor 1510 may be implemented as at least one of a proximity sensor, a touch sensor, a weight sensor, a temperature sensor, an illuminance sensor, and a magnetic sensor.

The temperature sensor 1520 may detect a temperature of the cooking appliance 2000 placed on the top plate of the wireless power transmission device 1000 or a temperature of the top plate of the wireless power transmission device 1000. The cooking appliance 2000 may be inductively heated up by the working coil 1120 of the wireless power transmission device 1000. The inductively heated cooking appliance 2000 may be overheated depending on a material of the cooking appliance 2000. Accordingly, the wireless power transmission device 1000 may detect by using the temperature sensor 1520, the temperature of the cooking appliance 2000 placed on the top plate or the temperature of the top plate, and when the cooking appliance 2000 or the top plate is overheated, may block the operation of the working coil 1120. The temperature sensor 1520 may be mounted in the vicinity of the working coil 1120. For example, the temperature sensor 1520 may be located at the center of the working coil 1120.

According to an example embodiment, the temperature sensor 1520 may include a thermistor of which electrical resistance value changes according to temperature. For example, the temperature sensor 1520 may include a negative temperature coefficient (NTC) temperature sensor, but the present disclosure is not limited thereto. The temperature sensor 1520 may also include a positive temperature coefficient (PTC) temperature sensor.

The memory 1600 may store programs for processing and controlling by the processor 1400. The memory 1600 may store pieces of input/output data (e.g., a plurality of power transmission patterns, cooking progress information of the cooking appliance 2000, etc.). The memory 1600 may store the AI model.

The memory 1600 may include at least one type of storage medium from among flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disk, and an optical disc. The programs stored in the memory 1600 may be classified into a plurality of modules depending on functions thereof. At least one AI model may be stored in the memory 1600. The wireless power transmission device 1000 may run, separately from the memory 1600, a web storage or a cloud server that performs a storage function on the Internet.

Hereinafter, structures of a general IH container, an IH cooking appliance, and a load cooking appliance will now be described with reference to FIG. 3.

FIG. 3 is a diagram illustrating the cooking appliance 2000 according to an example embodiment.

According to an embodiment, the cooking appliance 2000 may include a cooking container 20 (general IH container) including a magnetic material (IH metal), and the cooking appliance 2000 communicative with the wireless power transmission device 1000. The cooking appliance 2000 communicative with the wireless power transmission device 1000 may be defined as a small appliance. According to an example embodiment, the cooking appliance 2000 may include the induction heating load device 2000-1 including IH metal (e.g., an iron component), and the induced voltage load device 2000-2 including a reception coil 2003. The induction heating load device 2000-1 may be referred to as the IH cooking appliance. The induced voltage load device 2000-2 may be classified into a heater cooking appliance and a non-heating cooking appliance, depending on a type of a load.

According to an embodiment, the general IH container 20 may include various types of containers including a magnetic material. The general IH container 20 may be inductively heated up by the wireless power transmission device 1000. The general IH container 20 may be heated up by an induction heating scheme of heating IH metal by using electromagnetic induction. For example, when an AC is supplied to a working coil of the wireless power transmission device 1000, a temporally changing magnetic field may be induced inside the working coil. The magnetic field generated by the working coil may pass through the bottom surface of the general IH container 20. When the temporarily changing magnetic field passes through the IH metal (e.g., iron, steel, nickel, or various types of alloys) included in the bottom surface of the general IH container 20, a current rotating around the magnetic field may be generated in the IH metal. The current generated at the bottom surface of the general IH container 20 may be referred to as an eddy current. A phenomenon in which a current is induced by a temporally changing magnetic field in the IH metal of the general IH container 20 is referred to as electromagnetic induction. Heat may be generated at the bottom surface of the general IH container 20 by resistance of the eddy current and the IH metal (e.g., iron). Contents in the general IH container 20 may be heated up by the heat generated at the bottom surface of the general IH container 20.

According to an example embodiment, the general IH container 20 may include the IH metal, and thus, may be detected in an IH container detection mode (pan detection mode) of the wireless power transmission device 1000. The general IH container 20 is unable to communicate with the wireless power transmission device 1000, and thus, detection may not be possible in a small appliance detection mode of the wireless power transmission device 1000.

The cooking appliance 2000 may include a pickup coil 2001, a first temperature sensor 2006, a power module 2010, a controller 2020, and a communication interface 2030. In this regard, the power module 2010, the controller 2020, and the communication interface 2030 may be mounted on, directly or indirectly, a printed circuit board (PCB) 2005. The pickup coil 2001 may be a low-power coil that generates power for operating the PCB 2005. When power is supplied to the PCB 2005 via the pickup coil 2001, components mounted on, directly or indirectly, the PCB 2005 may be activated. For example, when power is supplied to the PCB 2005 via the pickup coil 2001, the controller 2020, the communication interface 2030, etc. may be activated. The power module 2010, the controller 2020, and the communication interface 2030 may be mounted on a single PCB or may be separately mounted on a plurality of PCBs. For example, the power module 2010 may be mounted on a first PCB, and the controller 2020 and the communication interface 2030 may be mounted, directly or indirectly, on a second PCB.

In a case of the induction heating load device 2000-1, as in the cooking container 20, an eddy current is generated in the IH metal, and accordingly, contents in the induction heating load device 2000-1 may be heated up. The induction heating load device 2000-1 may include a smart kettle, an electric rice cooker (smart pot), etc., but the present disclosure is not limited thereto.

The induction heating load device 2000-1 may include IH metal, and thus, may be detected in an IH container detection mode of the wireless power transmission device 1000. The induction heating load device 2000-1 may be communicative with the wireless power transmission device 1000, and thus, may be detected in the small appliance detection mode of the wireless power transmission device 1000.

The induced voltage load device 2000-2 may further include a reception coil 2003 and a load 2004, compared to the induction heating load device 2000-1. The reception coil 2003 may be a coil that receives wireless power transmitted from the wireless power transmission device 1000 so as to drive the load 2004. For example, a magnetic field generated from a current flowing in a transmission coil of the wireless power transmission device 1000 may pass through the reception coil 2003. As the magnetic field passes therethrough, an induced current may flow in the reception coil 2003. By the induced current flowing in the reception coil 2003, energy (power) may be supplied to the load 2004. Hereinafter, the induced current flowing in the reception coil 2003 by the magnetic field generated in the working coil may be expressed as that the reception coil 2003 receives wireless power from the working coil. According to an example embodiment, the reception coil 2003 may have a concentric circle shape or an elliptical shape, but the present disclosure is not limited thereto. According to an example embodiment, the reception coil 2003 may be provided in plural. For example, the induced voltage load device 2000-2 may include a reception coil for a warming heater and a reception coil for a heating heater. In this case, the reception coil for the heating heater may drive the heating heater, and the reception coil for the warming heater may drive the warming heater.

The load 2004 may include a heater, a motor, or a battery to be recharged, but the present disclosure is not limited thereto. The induced voltage load device 2000-2 including a heater may be referred to as a heater cooking appliance. The induced voltage load device 2000-2 including a motor, etc. may be referred to as a non-heating cooking appliance. The heater is to heat up the contents in the induced voltage load device 2000-2. The heater included in the heater cooking appliance may have various shapes, and an external cover of the heater cooking appliance may also have various materials (e.g., iron, stainless steel, copper, aluminum, Incoloy, Inconel, etc.). According to an example embodiment, the heater cooking appliance may also include a plurality of heaters. For example, the induced voltage load device 2000-2 may include a warming heater and a heating heater. The warming heater and the heating heater may produce different levels of heating output. For example, a heating level of the warming heater may be lower than a heating level of the heating heater.

According to an example embodiment, the induced voltage load device 2000-2 may further include a resonance capacitor (not shown) between the reception coil 2003 and the load 2004. In this case, a resonance value may be differently set according to an amount of power required by the load 2004. Also, according to an example embodiment, the induced voltage load device 2000-2 may further include a switch unit (e.g., a relay switch or a semiconductor switch) (not shown) for turning on/off the operation of the load 2004.

According to an example embodiment, the heater cooking appliance from (among, included in) the induced voltage load device 2000-2 may include a coffee maker (coffee dripper), a toaster, etc. According to an example embodiment, the non-heating cooking appliance from (among, included in) the induced voltage load device 2000-2 which includes the motor may include a blender.

The induced voltage load device 2000-2 does not include IH metal, and thus, may not be detected in the IH container detection mode of the wireless power transmission device 1000. The induced voltage load device 2000-2 is able to communicate with the wireless power transmission device 1000, and thus, may be detected in the small appliance detection mode of the wireless power transmission device 1000.

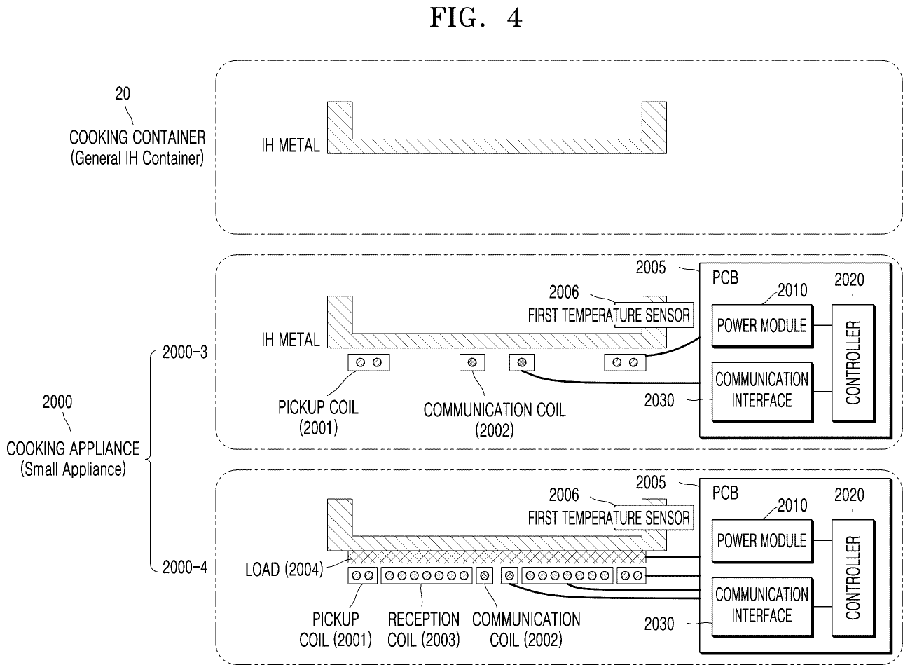

Hereinafter, structures of a general IH container, an IH cooking appliance including a communication coil, and a load cooking appliance including a communication coil will now be described with reference to FIG. 4.

FIG. 4 is a diagram illustrating the cooking appliance 2000 according to an example embodiment.

Referring to FIG. 4, the cooking appliance 2000 may further include a communication coil 2002. The communication coil 2002 may be a coil for performing short-range wireless communication with the wireless power transmission device 1000. In this case, the communication coil 2002 may include an NFC antenna coil for NFC communication. In FIG. 4, the number of windings of the communication coil 2002 is expressed as one, but the present disclosure is not limited thereto. The communication coil 2002 may be provided with a plurality of windings. For example, the communication coil 2002 may be wound in 5 or 6 turns. When the communication coil 2002 is the NFC antenna coil, the communication coil 2002 may be connected to an NFC circuit. The NFC circuit may receive power via the pickup coil 2001.

According to an example embodiment, in an induced voltage load device 2000-4, the pickup coil 2001, the communication coil 2002, and the reception coil 2003 may be arranged on the same layer. For example, referring to FIG. 4, the communication coil 2002 may be arranged on the innermost side, the reception coil 2003 may be arranged in the middle, and the pickup coil 2001 may be arranged on the outermost side, However, the present disclosure is not limited thereto, and the order of arranging the pickup coil 2001, the communication coil 2002, and the reception coil 2003 may be variously changed. For example, the reception coil 2003 may be arranged on the innermost side, the pickup coil 2001 may be arranged in the middle, and the communication coil 2002 may be arranged on the outermost side. Also, the reception coil 2003 may be arranged on the innermost side, the communication coil 2002 may be arranged in the middle, and the pickup coil 2001 may be arranged on the outermost side. The pickup coil 2001, the communication coil 2002, and the reception coil 2003 may be arranged in the following order from the innermost side.

1) Pickup coil 2001-Reception coil 2003-Communication coil 2002

2) Pickup coil 2001-Communication coil 2002-Reception coil 2003

3) Communication coil 2002-Pickup coil 2001-Reception coil 2003

According to an example embodiment, in the induced voltage load device 2000-4, the pickup coil 2001, the communication coil 2002, and the reception coil 2003 may be arranged in a stacked structure. For example, the pickup coil 2001 and the communication coil 2002, which do not have many windings, form one layer, and the reception coil 2003 forms another layer, such that two layers may be stacked.

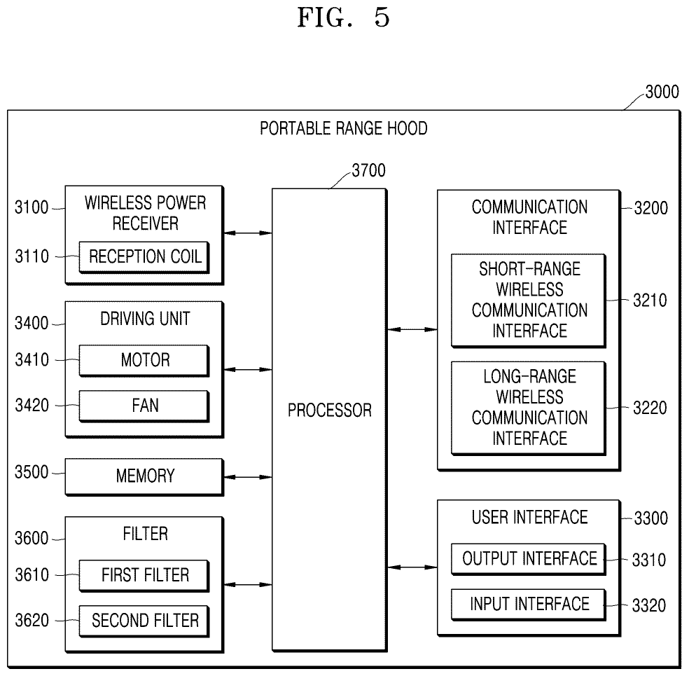

Hereinafter, elements consisting of the portable range hood 3000 will now be described with reference to FIG. 5.

FIG. 5 is a block diagram illustrating the portable range hood 3000 according to an example embodiment. The portable range hood 3000 may include a wireless power receiver 3100, a communication interface 3200, a user interface 3300, a driving unit 3400, a memory 3500, at least one filter 3600, and a processor 3700.

The wireless power receiver 3100 may receive power from the wireless power transmission device 1000. The wireless power transmission device 1000 may include a plurality of cooking zones. The wireless power receiver 3100 may be located on a first cooking zone from among the plurality of cooking zones. The wireless power receiver 3100 may receive power from the wireless power transmitter 1100 of the wireless power transmission device 1000 arranged in the first cooking zone. The wireless power transmitter 1100 may transmit received power to the driving unit 3400. The wireless power receiver 3100 may include a reception coil 3110.

The reception coil 3110 may be arranged to be close to the working coil 1120 arranged in the first cooking zone. A magnetic field generated around the working coil 1120 of the wireless power transmission device 1000 may be induced in the reception coil 3110.

The communication interface 3200 may establish wireless communication connection with the wireless power transmission device 1000 or the cooking appliance 2000 placed on the wireless power transmission device 1000. The communication interface 3200 may include a short-range wireless communication interface 3210 and a long-range wireless communication interface 3220.

The short-range wireless communication interface 3210 may include a Bluetooth communication interface, a BLE communication interface, an NFC interface, a WLAN (Wi-Fi) communication interface, a Zigbee communication interface, an IrDA communication interface, a WFD communication interface, an UWB communication interface, an Ant+ communication interface, etc., but the present disclosure is not limited thereto.

When the wireless power transmission device 1000 and the cooking appliance 2000 are remotely controlled by the server device (not shown) in an IoT environment, the long-range wireless communication interface 3220 may be used to communicate with the server device. The long-range wireless communication interface 3220 may include the Internet, a computer network (e.g., a LAN or a WAN), a mobile communication interface, etc. The mobile communication interface transmits or receives wireless signals to or from at least one of a base station, an external terminal, or a server, via a mobile communication network. Herein, the wireless signals may include various types of data based on transmission and reception of voice call signals, video call signals, or text/multimedia messages. The mobile communication interface may include a 3G module, a 4G module, an LTE module, a 5G module, a 6G module, an NB-IoT module, an LTE-M module, etc., but the present disclosure is not limited thereto.

The user interface 3300 may include an output interface 3310 and an input interface 3320. The output interface 3310 may include a display unit and a sound output unit.

The display unit may visually display information about an operation of the portable range hood 3000. For example, the display unit may output a GUI corresponding to a draw-in operation of the portable range hood For example, the display unit may output information about a draw-in operation state of the portable range hood 3000. For example, the display unit may visually output information about at least one of whether the portable range hood 3000 performs the draw-in operation, a strength of the draw-in operation, and a duration time of the draw-in operation.

The sound output unit may output audio data received via the communication interface 3200 or stored in the memory 3500. For example, the sound output unit may output an audio signal related to a function performed by the portable range hood 3000. For example, the sound output unit may output an audio guidance about a draw-in state of the portable range hood 3000. For example, when the portable range hood 3000 receives an operation command from the wireless power transmission device 1000, the output interface 3310 may display, on the display unit, a notification indicating that a draw-in operation of the portable range hood 3000 is set according to the operation command, or may output a voice guide via the sound output unit.

The input interface 3320 is arranged to receive an input from a user. For example, the input interface 3320 may include at least one of a key pad, a dome switch, a touch pad (using a touch capacitance method, a pressure-resistive layer method, an infrared sensing method, a surface ultrasonic conductive method, an integral tension measuring method, a piezo effect method, etc.), a jog wheel, and a jog switch, but the present disclosure is not limited thereto.

The driving unit 3400 may receive power from the wireless power transmitter 1100, and thus, may perform a draw-in operation of the portable range hood 3000. The draw-in operation may be an operation of drawing in air into the portable range hood 3000. The driving unit 3400 may include a motor 3410 and a fan 3420. The motor 3410 may receive power from the wireless power transmitter 1100. The motor 3410 may rotate the fan 3420. The fan 3420 may draw in outside air while rotating.

The memory 3500 may store programs for processing and controlling by the processor 3700. The memory 3500 may store pieces of input/output data (e.g., the operation command received from the wireless power transmission device 1000, information about the draw-in operation of the portable range hood 3000, etc.).

The at least one filter 3600 may perform filtering on oil vapor and odors included in the air drawn in by the portable range hood 3000. The at least one filter 3600 may filter out oil content included in the oil vapor. The at least one filter 3600 may have an odor-removal effect by which odors are deodorized. For example, the at least one filter 3600 may include a first filter 3610 for filtering out oil vapor included in air, and a second filter 3620 for filtering out odors included in air having passed through the first filter 3610. The first filter 3610 may be a metal filter or a non-metal filter, which has a mesh structure for filtering out oil content included in oil vapor. The second filter 3620 may be a deodorization filter having a porous structure, such as charcoal.

The processor 3700 may control all operations of the portable range hood 3000. The processor 3700 may execute the programs stored in the memory 3500 to control the wireless power receiver 3100 and the communication interface 3200.

According to an example embodiment, as the wireless power receiver 3100 of the portable range hood 3000 is located in a first cooking zone from among the plurality of cooking zones included in the wireless power transmission device 1000, the processor 3700 may receive power from the wireless power transmission device 1000, and thus, may activate the communication interface 3200. The processor 3700 may detect that the wireless power receiver 3100 is located in the first cooking zone. The processor 3700 may receive low power for activating the communication interface 3200 from the wireless power transmission device 1000.

According to an example embodiment, the processor 3700 may control the communication interface 3200 to receive, from the wireless power transmission device 1000, an operation command generated based on state information of the cooking appliance 2000 located in a second cooking zone from among the plurality of cooking zones included in the wireless power transmission device 1000. The cooking appliance 2000 may be placed on the second cooking zone. The cooking appliance 2000 may transmit the state information to the wireless power transmission device 1000. The wireless power transmission device 1000 may generate the operation command, based on the received state information. The operation command may be a command for overall controlling the draw-in operation of the portable range hood 3000. The processor 3700 may control the communication interface 3200 to receive the operation command.

According to an example embodiment, the processor 3700 may control the driving unit 3400 to set at least one of whether to perform the draw-in operation, a strength of the draw-in operation, and a duration time of the draw-in operation, based on the operation command. The processor 3700 may determine a necessity of the draw-in operation, based on the operation command, and thus, may determine whether to continue or stop the draw-in operation. The processor 3700 may adjust a strength of the draw-in operation by adjusting a rotation speed of the motor 3410, based on the operation command. For example, when it is necessary to increase the strength of the draw-in operation, based on the operation command, the processor 3700 may increase the rotation speed of the motor 3410. Accordingly, according to the present disclosure, oil vapor and odors which occur from the cooking appliance 2000 located in the second cooking zone may be efficiently removed by using the portable range hood 3000 located in the first cooking zone. Also, the processor 3700 of the portable range hood 3000 according to the present disclosure may control a draw-in operation, based on the operation command to which the state information of the cooking appliance 2000 is reflected, and thus, may provide a draw-in function corresponding to a current state of the cooking appliance 2000.

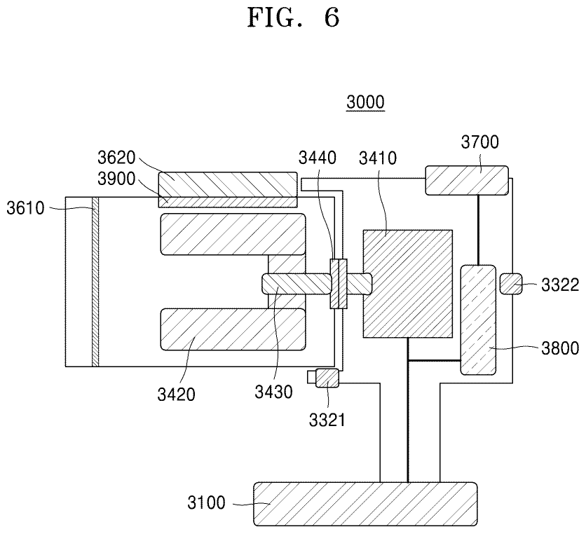

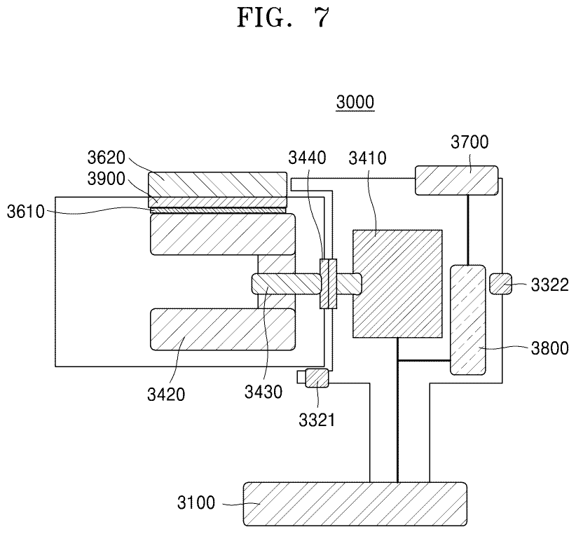

Hereinafter, a structure of the portable range hood 3000 will now be described with reference to FIGS. 6 and 7.

FIG. 6 is a diagram illustrating the portable range hood 3000 according to an example embodiment. FIG. 7 is a diagram illustrating the portable range hood 3000 according to an example embodiment.

According to an embodiment, the wireless power receiver 3100 may be arranged at a bottom surface of the portable range hood 3000, or may be arranged to be close to the bottom surface of the portable range hood 3000. For example, when the portable range hood 3000 has a main body and a bottom support structure, the wireless power receiver 3100 may be arranged at the bottom support structure. The bottom surface of the portable range hood 3000 may be placed on a first cooking zone of the wireless power transmission device 1000. The wireless power receiver 3100 may be adjacent to the first cooking zone of the wireless power transmission device 1000. A magnetic field may be induced in the reception coil 3110 of the wireless power receiver 3100, due to a magnetic field generated by the working coil 1120 of the first cooking zone.

According to an embodiment, the driving unit 3400 may operate by receiving power from the wireless power receiver 3100. The driving unit 3400 may include the motor 3410, a shaft 3430 forming a rotation shaft of the motor 3410, and the fan 3420 rotating by being connected, directly or indirectly, to the shaft 3430. For example, the shaft 3430 may be arranged to penetrate through a center of the fan 3420. The motor 3410 and the shaft 3430 may be connected by a connection part 3440.

The driving unit 3400 may draw in air including oil vapor and odors. As the driving unit 3400 draws in the air, the air may be introduced from a first direction which the shaft 3430 faces. The air may be introduced from the front of the fan 3420, may pass through the fan 3420, and may be flown into the portable range hood 3000.

The at least one filter 3600 may include the first filter 3610 for filtering out oil vapor included in air, and the second filter 3620 for filtering out odors included in air having passed through the first filter 3610. The first filter 3610 may be a metal filter or a non-metal filter, which has a mesh structure for filtering out oil content included in oil vapor. The second filter 3620 may be a deodorization filter having a porous structure, such as charcoal.

Compared to the second filter 3620, the first filter 3610 may be arranged to be closer to an inlet into which air is drawn by a draw-in operation of the portable range hood 3000. Compared to the first filter 3610, the second filter 3620 may be arranged to be closer to a vent 3900 from which air is discharged. Accordingly, the air drawn by the draw-in operation of the portable range hood 3000 may pass through the first filter 3610 and then may be discharged through the second filter 3620.

For example, as illustrated in FIG. 6, the first filter 3610 may be arranged at the inlet. When the first filter 3610 is arranged at the front of the inlet, air from which oil vapor has been filtered out is flown into the fan 3420, so that a degree at which the fan 3420 is contaminated by oil vapor may be decreased, and a cleaning period of the fan 3420 may be increased. For example, as shown in FIG. 7, the first filter 3610 may be arranged at a lower part of the vent 3900. When the first filter 3610 is arranged at the lower part of the vent 3900, a filter is not arranged at the front of the portable range hood 3000, so that the contaminated first filter 3610 may be easily blocked from a user's gaze, and an aesthetic impression may be improved. The second filter 3620 may be arranged at an upper part of the vent 3900.

The input interface 3320 may include a first button 3321 and a second button 3322. The first button 3321 and the second button 3322 may allow a user to easily perform cleaning of the portable range hood 3000 and control of the portable range hood 3000. For example, the first button 3321 may be a button for manually detaching an external case of the portable range hood 3000. For example, the second button 3322 may be a button for controlling turn-on and turn-off of the portable range hood 3000. For example, the second button 3322 may be a button for manually starting a draw-in operation of the portable range hood 3000.

A PCB 3800 may be electrically connected, directly or indirectly, to the wireless power receiver 3100, the motor 3410, and the processor 3700. A power distribution circuit for distributing power received from the wireless power receiver 3100 may be arranged at the PCB 3800. A control circuit for controlling whether to rotate and a rotation speed of the motor 3410 may be arranged at the PCB 3800. A signal transmission and reception circuit for delivering control signals to be delivered to the processor 3700 or delivering control signals generated by the processor 3700 may be arranged at the PCB 3800.

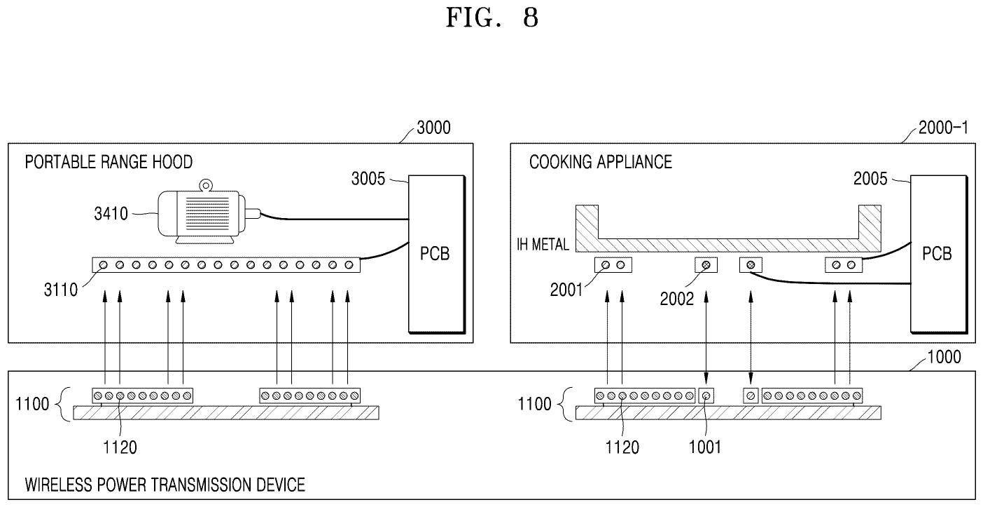

Hereinafter, a process in which the wireless power transmission device 1000 transmits power to the induction heating load device 2000-1 and the portable range hood 3000 will now be described with reference to FIG. 8.

FIG. 8 is a diagram illustrating that the wireless power transmission device 1000 transmits power according to an example embodiment.

According to an example embodiment, the wireless power transmission device 1000 may include the working coil 1120 and a communication coil 1001. For example, the communication coil 1001 may include an NFC antenna coil for NFC communication. In FIG. 8, the number of windings of the communication coil 1001 is expressed as one, but the present disclosure is not limited thereto. The communication coil 1001 may be provided with a plurality of windings. For example, the communication coil 1001 may be wound in 5 or 6 turns.

According to an example embodiment, the communication coil 1001 included in the wireless power transmission device 1000 and the communication coil 2002 included in the induction heating load device 2000-1 may be arranged at locations corresponding to each other. For example, when the communication coil 1001 included in the wireless power transmission device 1000 is arranged at the center of a cooking zone of the wireless power transmission device 1000, the communication coil 2002 included in the induction heating load device 2000-1 may be arranged at the bottom center of the induction heating load device 2000-1.

According to an example embodiment, at least some of the reception coil 3110 included in the portable range hood 3000 and the working coil 1120 included in the wireless power transmission device 1000 may be arranged at locations corresponding to each other. For example, as the reception coil 3110 included in the portable range hood 3000 is arranged in an entire cooking zone, at least some of the reception coil 3110 may be arranged to correspond to the working coil 1120 arranged at an edge of the cooking zone.

In an embodiment, when the induction heating load device 2000-1 and the portable range hood 3000 are placed on the wireless power transmission device 1000, the wireless power transmission device 1000 may supply power to the pickup coil 2001 and the reception coil 3110 via the working coil 1120. When the wireless power transmission device 1000 wirelessly transmits power via the working coil 1120, an eddy current is generated in the induction heating load device 2000-1, and accordingly, contents in the induction heating load device 2000-1 may be heated up, and simultaneously, induced power may occur in the reception coil 3110. The power induced in the reception coil 3110 may be transmitted to the motor 3410 via a PCB 3005, and thus, may drive the motor 3410.

With reference to FIG. 7, a case in which the wireless power transmission device 1000 includes the communication coil 1001 is described as an example, but, when the induction heating load device 2000-1 does not include the communication coil 2002 (see FIG. 3), the wireless power transmission device 1000 may not include the communication coil 1001.

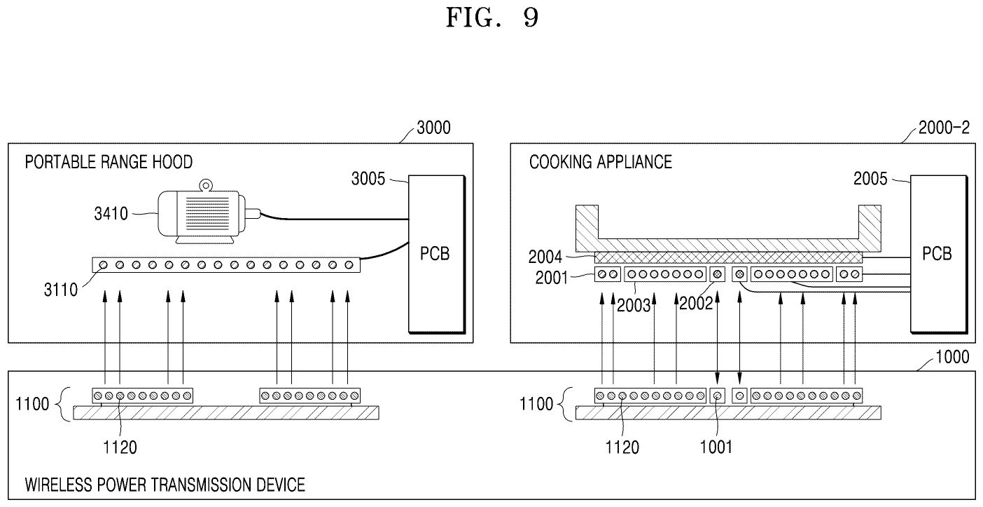

Hereinafter, a process in which the wireless power transmission device 1000 transmits power to the induced voltage load device 2000-2 and the portable range hood 3000 will now be described with reference to FIG. 9.

FIG. 9 is a diagram illustrating that the wireless power transmission device 1000 transmits power according to an example embodiment.

According to an example embodiment, the wireless power transmission device 1000 may include the working coil 1120 and a communication coil 1001. For example, the communication coil 1001 may include an NFC antenna coil for NFC communication. In FIG. 9, the number of windings of the communication coil 1001 is expressed as one, but the present disclosure is not limited thereto. The communication coil 1001 may be provided with a plurality of windings. For example, the communication coil 1001 may be wound in 5 or 6 turns.

According to an example embodiment, the communication coil 1001 included in the wireless power transmission device 1000 and the communication coil 2002 included in the induced voltage load device 2000-2 may be arranged at locations corresponding to each other. For example, when the communication coil 1001 included in the wireless power transmission device 1000 is arranged at the center of the cooking zone of the wireless power transmission device 1000, the communication coil 2002 included in the induced voltage load device 2000-2 may be arranged at the bottom center of the induced voltage load device 2000-2.

According to an example embodiment, at least some of the reception coil 3110 included in the portable range hood 3000 and the working coil 1120 included in the wireless power transmission device 1000 may be arranged at locations corresponding to each other. For example, as the reception coil 3110 included in the portable range hood 3000 is arranged in an entire cooking zone, at least some of the reception coil 3110 may be arranged to correspond to the working coil 1120 arranged at an edge of the cooking zone.

When the induced voltage load device 2000-2 and the portable range hood 3000 are placed on the wireless power transmission device 1000, the wireless power transmission device 1000 may supply power to the pickup coil 2001 and the reception coil 3110 via the working coil 1120. Also, when the wireless power transmission device 1000 wirelessly transmits power via the working coil 1120, an induced current flows in the reception coil 2003 of the induced voltage load device 2000-2, such that energy may be supplied to the load 2004, and simultaneously, induced power may occur in the reception coil 3110. The power induced in the reception coil 3110 may be transmitted to the motor 3410 via the PCB 3005, and thus, may drive the motor 3410. The load 2004 may be arranged at a location apart from the reception coil 2003. The load 2004 may include a motor or a heater. For example, when the induced voltage load device 2000-2 is a coffee dripper, power generated by the induced current may supply energy to a heater of the coffee dripper. For example, when the induced voltage load device 2000-2 is a blender, power generated by the induced current may drive a motor of the blender.

With reference to FIG. 9, a case in which the wireless power transmission device 1000 includes the communication coil 1001 is described as an example, but, when the induced voltage load device 2000-2 does not include the communication coil 2002 (see FIG. 3), the wireless power transmission device 1000 may not include the communication coil 1001.

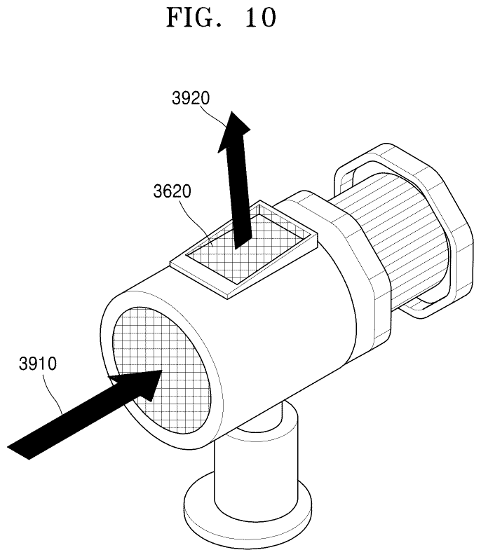

Hereinafter, a flow of air according to a draw-in operation of the portable range hood 3000 will now be described with reference to FIG. 10.

FIG. 10 is a diagram illustrating air being flown into and exhausted from the portable range hood 3000 according to an example embodiment.

According to an embodiment, the portable range hood 3000 may draw in air including oil vapor and odors via a draw-in operation. The portable range hood 3000 may draw in the air via a draw-in path 3910. When the first filter 3610 is arranged at the inlet, the air may be flown into the draw-in path 3910, such that oil vapor may be filtered out. The air flown into the draw-in path 3910 may pass through the inside of the portable range hood 3000.

According to an embodiment, the portable range hood 3000 may externally exhaust the internally drawn air via the vent 3900. The portable range hood 3000 may exhaust air via an exhaust path 3920. When the first filter 3610 is arranged at the lower part of the vent 3900, air is exhausted via the exhaust path 3920, so that oil vapor may be filtered out. As the second filter 3620 is arranged at the upper part of the vent 3900, air is exhausted via the exhaust path 3920, so that odors may be filtered out. Accordingly, air from which oil vapor and odors have been removed may be exhausted via the exhaust path 3920.

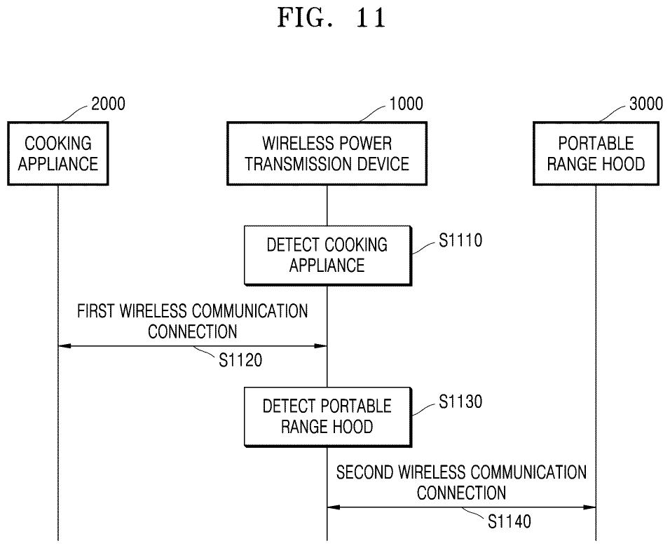

Hereinafter, an operation in which the wireless power transmission device 1000, the cooking appliance 2000, and the portable range hood 3000 perform wireless communication connection will now be described with reference to FIG. 11.

FIG. 11 is a flowchart illustrating a communication connection method by the portable range hood 3000 according to an example embodiment.

In operation S1110, the wireless power transmission device 1000 according to an embodiment may detect the cooking appliance 2000. The cooking appliance 2000 may be arranged on any cooking zone from among a plurality of cooking zones included in the wireless power transmission device 1000. The processor 1400 of the wireless power transmission device 1000 may detect that the cooking appliance 2000 is arranged on a cooking zone. For example, when the cooking appliance 2000 (e.g., a general IH container, an IH cooking appliance) including the magnetic material is placed on the top plate, the processor 1400 may enter an IH container detection mode (pan detection mode). For example, based on a change in a current value (inductance) of the working coil 1120 due to approach of the cooking appliance 2000, the processor 1400 having entered the IH container detection mode may detect that the cooking appliance 2000 is located on the top plate of the wireless power transmission device 1000. For example, the processor 1400 may detect the cooking appliance 2000 by receiving a packet transmitted from the cooking appliance 2000 located on the top plate, by using short-range wireless communication (e.g., BLE or Bluetooth) supported by the communication interface 1200 in the small appliance detection mode.

In operation S1120, the wireless power transmission device 1000 and the cooking appliance 2000 according to an embodiment may establish first wireless communication connection. The wireless power transmission device 1000 in the small appliance detection mode may transmit power for activating the communication interface 2030 of the cooking appliance 2000 via the plurality of cooking zones. The processor 1400 of the wireless power transmission device 1000 may control the wireless power transmitter 1100 to transmit low power for activating the communication interface 2030 of the cooking appliance 2000. The communication interface 2030 of the cooking appliance 2000 may be activated by receiving low power, and thus, may transmit identification information. The identification information may include at least one of a

MAC address, a model type, load device type information (e.g., an IH type ID, a heater type ID, a motor type ID, or a small appliance type ID), manufacturer information (e.g., manufacturer ID), a serial number, and manufacture time information (year/month/day of the manufacture), For example, the load device type information may include information indicating whether the cooking appliance 2000 is the induction heating load device 2000-1 (IH type ID), the induced voltage load device 2000-2 having a heater (heater type ID), or the induced voltage load device 2000-2 having a motor (motor type ID).

In operation S1130, the wireless power transmission device 1000 according to an embodiment may detect the portable range hood 3000. The portable range hood 3000 may be arranged on any one cooking zone from among the plurality of cooking zones included in the wireless power transmission device 1000. The portable range hood 3000 may be arranged on a cooking zone different from the cooking appliance 2000. For example, the portable range hood 3000 may be arranged on a first cooking zone, and the cooking appliance 2000 may be arranged on a second cooking zone. The processor 1400 of the wireless power transmission device 1000 may detect that the portable range hood 3000 is arranged on a cooking zone. For example, based on a change in a current value (inductance) of the working coil 1120 due to approach of the reception coil 3110 included in the wireless power receiver 3100 of the portable range hood 3000 when the portable range hood 3000 is placed on the top plate, the processor 1400 may detect that the portable range hood 3000 is located on the top plate of the wireless power transmission device 1000. For example, the processor 1400 may detect the portable range hood 3000 by receiving a packet transmitted from the portable range hood 3000 located on the top plate, by using short-range wireless communication (e.g., BLE or Bluetooth) supported by the communication interface 1200.

In operation S1140, the wireless power transmission device 1000 and the portable range hood 3000 according to an embodiment may establish second wireless communication connection. The processor 1400 of the wireless power transmission device 1000 may control the wireless power transmitter 1100 to transmit low power for activating the communication interface 3200 of the portable range hood 3000. The communication interface 3200 of the portable range hood 3000 may be activated by receiving low power, and thus, may transmit a response signal. The processor 1400 of the wireless power transmission device 1000 may receive the response signal of the portable range hood 3000, and may transmit power for driving the portable range hood 3000.

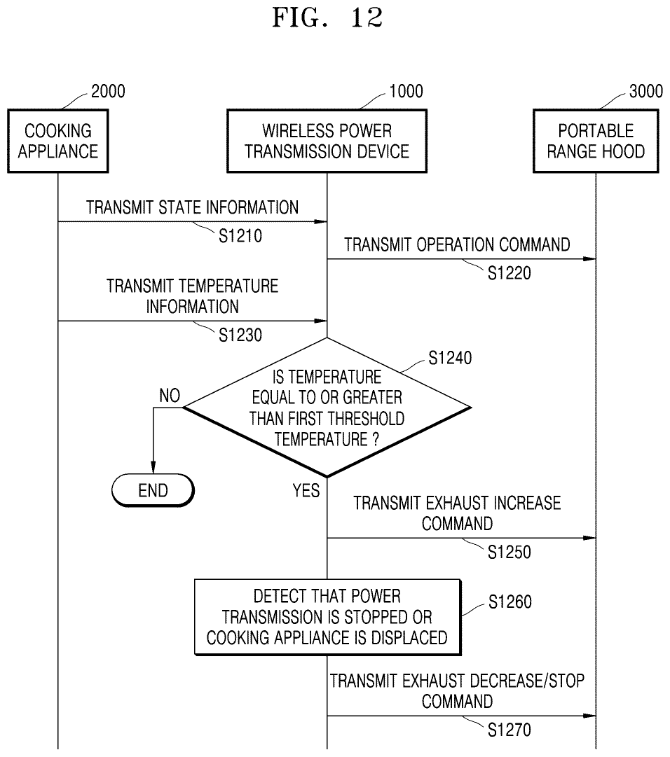

Hereinafter, a method of setting a draw-in operation of the portable range hood 3000 by using an operation command, in particular, a command related to a temperature, and controlling exhaust of the portable range hood 3000 will now be described with reference to FIG. 12.

FIG. 12 is a flowchart illustrating an exhaust control method by the portable range hood 3000 according to an example embodiment.

In operation S1210, the wireless power transmission device 1000 according to an embodiment may receive state information from the cooking appliance 2000. The cooking appliance 2000 may receive power from the wireless power transmission device 1000. As the cooking appliance 2000 receives the power, contents in the cooking appliance 2000 may be heated up. The cooking appliance 2000 may transmit the state information. The state information may be information indicating a location of the cooking appliance 2000, a current cooking state of the cooking appliance 2000, and a height of the cooking appliance 2000. The state information may include at least one of location information of a second cooking zone in which the cooking appliance 2000 is placed, temperature information of the cooking appliance 2000 or the second cooking zone, and height information of the cooking appliance 2000. The processor 1400 of the wireless power transmission device 1000 may control the communication interface 1200 to receive the state information from the cooking appliance 2000.

In operation S1220, the wireless power transmission device 1000 according to an embodiment may transmit an operation command to the portable range hood 3000. The processor 1400 may generate the operation command, based on the state information. The operation command may be a command to which information related to oil vapor or odors which occurs from the cooking appliance 2000 has been reflected. For example, the operation command may be a command generated based on temperature information of the cooking appliance 2000, recipe progress information of the cooking appliance 2000, and information related to oil vapor or odors which occurs from the cooking appliance 2000. The operation command may be a command for controlling a draw-in operation of the portable range hood 3000, and exhaust according to the draw-in operation. The operation command may be a command for setting whether the portable range hood 3000 performs the draw-in operation, a strength of the draw-in operation, and a duration time of the draw-in operation.

In operation S1230, the wireless power transmission device 1000 may receive the temperature information from the cooking appliance 2000. The temperature information may be information about a temperature of the cooking appliance 2000, a temperature of contents in the cooking appliance 2000, or a temperature of a cooking zone in which the cooking appliance 2000 is placed. The cooking appliance 2000 may measure the temperature of the cooking appliance 2000 by using a temperature sensor, and may transmit the measured temperature. The cooking appliance 2000 may transmit the temperature information at every set period. For example, the cooking appliance 2000 may transmit the temperature information whenever the cooking appliance 2000 reaches a particular temperature. For example, the cooking appliance 2000 may transmit the temperature information at a first point in time when it reaches 50° C. and a second point in time when it reaches 100° C. The processor 1400 of the wireless power transmission device 1000 may control the communication interface 1200 to receive the temperature information.

In operation S1240, the wireless power transmission device 1000 may determine whether the temperature is equal to or greater than a first threshold temperature. The first threshold temperature may be a temperature in which oil vapor and odors occur by a threshold value or more, due to food being cooked in the cooking appliance 2000. The first threshold temperature may be a threshold temperature at which it is necessary to control a draw-in operation and exhaust of the portable range hood 3000. The processor 1400 of the wireless power transmission device 1000 may determine whether a temperature according to the temperature information received from the cooking appliance 2000 is equal to or greater than the first threshold temperature. When the temperature is equal to or greater than the first threshold temperature (operation S1240—YES), the processor 1400 may proceed to operation S1250. When the temperature is less than the first threshold temperature (operation S1240—NO), the processor 1400 may end an operation.

In operation S1250, the wireless power transmission device 1000 may transmit an exhaust increase command to the portable range hood 3000. The exhaust increase command may be a control command for increasing a strength of the draw-in operation of the portable range hood 3000 and increasing exhaust. When the temperature is equal to or greater than the first threshold temperature, the processor 1400 of the wireless power transmission device 1000 may determine to increase the strength of the draw-in operation of the portable range hood 3000 and increase exhaust. The processor 1400 may control the communication interface 1200 to transmit the exhaust increase command to the portable range hood 3000.

The portable range hood 3000 may receive the exhaust increase command from the wireless power transmission device 1000. The processor 3700 of the portable range hood 3000 may control the communication interface 3200 to receive the exhaust increase command. The processor 3700 may control the driving unit 3400 to increase the strength of the draw-in operation and increase exhaust, based on the exhaust increase command. The driving unit 3400 may increase the strength of the draw-in operation and increase exhaust by increasing a rotation speed of the motor 3410. Accordingly, the portable range hood 3000 may effectively draw in and remove oil vapor and odors which occur in the cooking appliance 2000 having the temperature equal to or greater than the first threshold temperature.

In operation S1260, the wireless power transmission device 1000 may detect that power transmission is stopped or the cooking appliance 2000 is displaced. For example, the processor 1400 of the wireless power transmission device 1000 may stop power transmission to the cooking appliance 2000, according to a power stop input of the input interface 1320. For example, when cooking by the cooking appliance 2000 is completed, based on recipe information received from the cooking appliance 2000, the processor 1400 may stop power transmission to the cooking appliance 2000. For example, the processor 1400 may detect displacement of the cooking appliance 2000 by using the container detection sensor 1510 arranged in a cooking zone. When the processor 1400 detects power transmission stop or displacement of the cooking appliance 2000, the processor 1400 may determine that occurrence of oil vapor and odors is decreased or stopped in the cooking appliance 2000.

In operation S1270, the wireless power transmission device 1000 may transmit an exhaust decrease command or an exhaust stop command to the portable range hood 3000. The exhaust decrease command may be a control command for decreasing the strength of the draw-in operation of the portable range hood 3000 and decreasing exhaust. The exhaust stop command may be a control command for stopping the draw-in operation of the portable range hood 3000 and stopping exhaust. When the processor 1400 of the wireless power transmission device 1000 detects power transmission stop, the processor 1400 may determine that it is required to decrease the strength of the draw-in operation of the portable range hood 3000 and decrease exhaust. The processor 1400 may control the communication interface 1200 to transmit the exhaust decrease command to the portable range hood 3000. When the processor 1400 detects displacement of the cooking appliance 2000, the processor 1400 may determine that it is required to stop the draw-in operation of the portable range hood 3000 and stop exhaust. The processor 1400 may control the communication interface 1200 to transmit the exhaust stop command to the portable range hood 3000. However, the present disclosure is not limited thereto, and when the processor 1400 detects power transmission stop or displacement of the cooking appliance 2000, the processor 1400 may transmit an operation command for controlling the portable range hood 3000 to maintain the draw-in operation and exhaust for a preset time, and then to stop the draw-in operation and exhaust after an elapse of the preset time.

The portable range hood 3000 may receive the exhaust decrease command from the wireless power transmission device 1000. The processor 3700 of the portable range hood 3000 may control the communication interface 3200 to receive the exhaust decrease command. The processor 3700 may control the driving unit 3400 to decrease the strength of the draw-in operation and decrease exhaust, based on the exhaust decrease command. The driving unit 3400 may decrease the strength of the draw-in operation and decrease exhaust by decreasing the rotation speed of the motor 3410. Accordingly, the portable range hood 3000 may decrease the draw-in operation with respect to the cooking appliance 2000 that has stopped receiving power.

The portable range hood 3000 may receive the exhaust stop command from the wireless power transmission device 1000. The processor 3700 of the portable range hood 3000 may control the communication interface 3200 to receive the exhaust stop command. The processor 3700 may control the driving unit 3400 to stop the draw-in operation and stop exhaust, based on the exhaust stop command. The driving unit 3400 may stop the draw-in operation and stop exhaust by stopping the rotation speed of the motor 3410. Accordingly, when the cooking appliance 2000 stops the wireless power transmission device 1000, the portable range hood 3000 may stop the draw-in operation.

The portable range hood 3000 may receive, from the wireless power transmission device 1000, a control operation command for maintaining the draw-in operation and exhaust for a preset time and then stopping the draw-in operation and exhaust after an elapse of the preset time. The processor 3700 of the portable range hood 3000 may maintain the draw-in operation and exhaust for the preset time and then may stop the draw-in operation and exhaust after an elapse of the preset time, based on the operation command. The processor 3700 may control the draw-in operation and exhaust of the portable range hood 3000, based on the operation command including information about an operation to be performed or having reflected thereto additional information for determining whether to perform the operation.

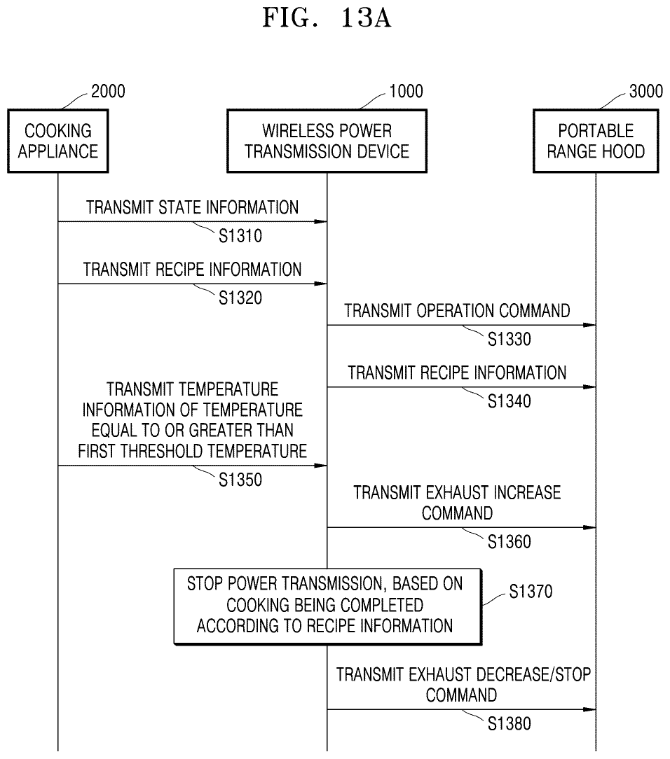

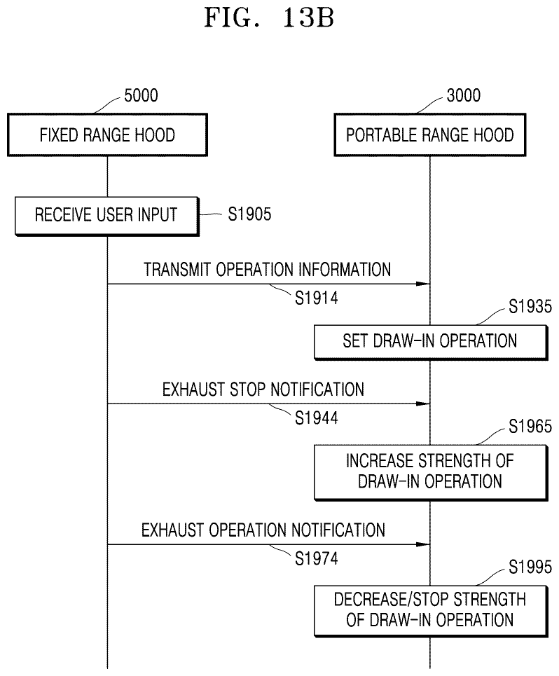

Hereinafter, a method of setting a draw-in operation of the portable range hood 3000 and controlling exhaust of the portable range hood 3000, by using an operation command, in particular, a command related to recipe information, will now be described with reference to FIGS. 13A and 13B.

FIG. 13A is a flowchart illustrating a power transmission method by the wireless power transmission device 1000 according to an example embodiment. FIG. 13B is a flowchart illustrating an exhaust control method by the portable range hood 3000 according to an example embodiment.

In operation S1310, the wireless power transmission device 1000 according to an embodiment may receive state information from the cooking appliance 2000. The cooking appliance 2000 may receive power from the wireless power transmission device 1000. As the cooking appliance 2000 receives the power, contents in the cooking appliance 2000 may be heated up. The cooking appliance 2000 may transmit the state information. The state information may be information indicating a location of the cooking appliance 2000, a current cooking state of the cooking appliance 2000, and a height of the cooking appliance 2000. The state information may include at least one of location information of a second cooking zone in which the cooking appliance 2000 is placed, temperature information of the cooking appliance 2000 or the second cooking zone, and height information of the cooking appliance 2000. The processor 1400 of the wireless power transmission device 1000 may control the communication interface 1200 to receive the state information from the cooking appliance 2000.

In operation S1320, the wireless power transmission device 1000 according to an embodiment may receive recipe information. Referring to FIG. 13A, the cooking appliance 2000 may store recipe information for cooking contents. The recipe information may differ according to a type of the cooking appliance 2000, and may include a plurality of recipes. For example, when the cooking appliance 2000 is a coffee dripper, the recipe information may include a list of coffee bean recipes, when the cooking appliance 2000 is a smart pot, the recipe information may include a list of cooking recipes, and when the cooking appliance 2000 is a blender, the recipe information may include a list of beverage recipes. When cooking starts, the cooking appliance 2000 may transmit the stored recipe information to the wireless power transmission device 1000. The wireless power transmission device 1000 may receive the recipe information, and may transmit power to the cooking appliance 2000, based on the received recipe information. Referring to FIG.

13B, the recipe information may be stored in the wireless power transmission device 1000. The wireless power transmission device 1000 may perform operation S1320 and operation S1310 at a same time or different points in time.

In operation S1330, the wireless power transmission device 1000 according to an embodiment may transmit an operation command to the portable range hood 3000. The processor 1400 may generate the operation command, based on the state information. The operation command may be a command to which information related to oil vapor or odors which occurs from the cooking appliance 2000 has been reflected. For example, the operation command may be a command generated based on temperature information of the cooking appliance 2000, recipe progress information of the cooking appliance 2000, and information related to oil vapor or odors which occurs from the cooking appliance 2000. The operation command may be a command for controlling a draw-in operation of the portable range hood 3000, and exhaust according to the draw-in operation. The operation command may be a command for setting whether the portable range hood 3000 performs the draw-in operation, a strength of the draw-in operation, and a duration time of the draw-in operation.

In operation S1340, the wireless power transmission device 1000 according to an embodiment may transmit the recipe information to the portable range hood 3000. The processor 3700 of the portable range hood 3000 may control the communication interface 3200 to receive the recipe information. The processor 3700 of the portable range hood 3000 may perform a draw-in operation, based on the recipe information. The wireless power transmission device 1000 may perform operation S1340 and operation S1330 at a same time or different points in time. Accordingly, the processor 3700 of the portable range hood 3000 may receive the operation command and the recipe information at a same time or different points in time.

In operation S1350, the wireless power transmission device 1000 according to an embodiment may receive temperature information of a temperature equal to or greater than a first threshold temperature from the cooking appliance 2000. The first threshold temperature may be a temperature in which oil vapor and odors occur by a threshold value or more, due to food being cooked in the cooking appliance 2000. The first threshold temperature may be a threshold temperature at which it is necessary to control a draw-in operation and exhaust of the portable range hood 3000. When the processor 1400 of the wireless power transmission device 1000 receives the temperature information of the temperature equal to or greater than the first threshold temperature, the processor 1400 may determine that it is required to control the draw-in operation and exhaust of the portable range hood 3000.

In operation S1360, the wireless power transmission device 1000 according to an embodiment may transmit an exhaust increase command to the portable range hood 3000. The exhaust increase command may be a control command for increasing a strength of the draw-in operation of the portable range hood 3000 and increasing exhaust. When the temperature is equal to or greater than the first threshold temperature, the processor 1400 of the wireless power transmission device 1000 may determine to increase the strength of the draw-in operation of the portable range hood 3000 and increase exhaust. The processor 1400 may control the communication interface 1200 to transmit the exhaust increase command to the portable range hood 3000.

The portable range hood 3000 may receive the exhaust increase command from the wireless power transmission device 1000. The processor 3700 of the portable range hood 3000 may control the communication interface 3200 to receive the exhaust increase command. The processor 3700 may control the driving unit 3400 to increase the strength of the draw-in operation and increase exhaust, based on the exhaust increase command. The driving unit 3400 may increase the strength of the draw-in operation and increase exhaust by increasing a rotation speed of the motor 3410. Accordingly, the portable range hood 3000 may effectively draw in and remove oil vapor and odors which occur in the cooking appliance 2000 having the temperature equal to or greater than the first threshold temperature.

In operation S1370, the wireless power transmission device 1000 according to an embodiment may stop power transmission, based on cooking being completed according to the recipe information. The processor 1400 of the wireless power transmission device 1000 may set a cooking time, based on the recipe information. When the cooking time elapses, the processor 1400 may stop power transmission to the cooking appliance 2000.

In operation S1380, the wireless power transmission device 1000 according to an embodiment may transmit an exhaust decrease command or an exhaust stop command to the portable range hood 3000. When the power transmission to the cooking appliance 2000 is stopped, the processor 1400 of the wireless power transmission device 1000 may determine that occurrence of oil vapor and odors is decreased or stopped from the cooking appliance 2000. The processor 1400 may control the communication interface 1200 to transmit the exhaust decrease command or the exhaust stop command to the portable range hood 3000. However, the present disclosure is not limited thereto, and when the processor 1400 detects power transmission stop or displacement of the cooking appliance 2000, the processor 1400 may transmit an operation command for controlling the portable range hood 3000 to maintain the draw-in operation and exhaust for a preset time, and then to stop the draw-in operation and exhaust after an elapse of the preset time.

The portable range hood 3000 may receive the exhaust decrease command from the wireless power transmission device 1000. The processor 3700 of the portable range hood 3000 may control the communication interface 3200 to receive the exhaust decrease command. The processor 3700 may control the driving unit 3400 to decrease the strength of the draw-in operation and decrease exhaust, based on the exhaust decrease command. The driving unit 3400 may decrease the strength of the draw-in operation and decrease exhaust by decreasing the rotation speed of the motor 3410. Accordingly, the portable range hood 3000 may decrease the draw-in operation with respect to the cooking appliance 2000 that has stopped receiving power, based on cooking being completed according to the recipe information.

The portable range hood 3000 may receive the exhaust stop command from the wireless power transmission device 1000. The processor 3700 of the portable range hood 3000 may control the communication interface 3200 to receive the exhaust stop command. The processor 3700 may control the driving unit 3400 to stop the draw-in operation and stop exhaust, based on the exhaust stop command. The driving unit 3400 may stop the draw-in operation and stop exhaust by stopping the rotation speed of the motor 3410. Accordingly, the portable range hood 3000 may stop the draw-in operation with respect to the cooking appliance 2000 that has stopped receiving power, based on cooking being completed according to the recipe information.

The portable range hood 3000 may receive, from the wireless power transmission device 1000, a control operation command for maintaining the draw-in operation and exhaust for a preset time and then stopping the draw-in operation and exhaust after an elapse of the preset time. With respect to the cooking appliance 2000 that has stopped receiving power, based on cooking being completed according to the recipe information, the processor 3700 of the portable range hood 3000 may maintain the draw-in operation and exhaust for the preset time and then may stop the draw-in operation and exhaust after an elapse of the preset time, based on the operation command. In this manner, the processor 3700 may control the draw-in operation and exhaust of the portable range hood 3000, based on the operation command to which the recipe information has been reflected.

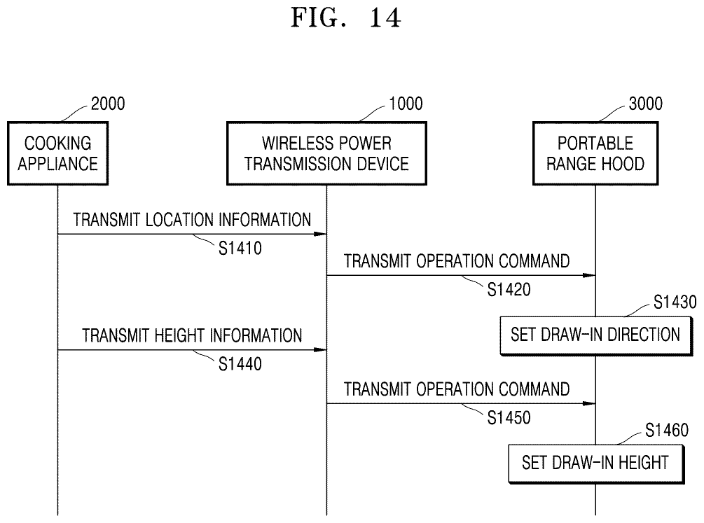

Hereinafter, a method of setting a draw-in direction and a draw-in height of the portable range hood 3000 by using an operation command, in particular, a command related to location information and height information, will now be described with reference to FIG. 14.

FIG. 14 is a flowchart illustrating a method of setting a draw-in direction and a draw-in height of the portable range hood 3000 according to an example embodiment.

In operation S1410, the wireless power transmission device 1000 according to an embodiment may receive location information from the cooking appliance 2000. The location information may be information about a location of a cooking zone of the wireless power transmission device 1000, in which the cooking appliance 2000 is placed. For example, the location information may be information about a location of a burner or a number of the burner on which the cooking appliance 2000 is placed. The cooking appliance 2000 may generate and transmit the location information to the wireless power transmission device 1000. The cooking appliance 2000 may include the location information in state information and may transmit the state information to the wireless power transmission device 1000. The processor 1400 of the wireless power transmission device 1000 may control the communication interface 1200 to receive the location information.

In operation S1420, the wireless power transmission device 1000 may transmit an operation command to the portable range hood 3000. The processor 1400 of the wireless power transmission device 1000 may generate the operation command, based on the location information. The operation command generated based on the location information may include a command for controlling a draw-in operation of the portable range hood 3000 by having reflected thereto the location of the cooking appliance 2000 according to the location information. The portable range hood 3000 may receive the operation command from the wireless power transmission device 1000. The processor 3700 of the portable range hood 3000 may control the communication interface 3200 to receive the operation command from the wireless power transmission device 1000.

In operation S1430, the portable range hood 3000 may set a draw-in direction. The draw-in direction may be a direction in which the inlet via which the portable range hood 3000 draws in air faces. For example, the portable range hood 3000 may include a support part capable of adjusting the draw-in direction of the portable range hood 3000. The processor 3700 of the portable range hood 3000 may control the support part to adjust the draw-in direction, based on the operation command. For example, the processor 3700 may set the draw-in direction to face a location in which the cooking appliance 2000 is placed, based on the operation command. Accordingly, it is possible to set the draw-in direction of the portable range hood 3000 to face a location in which the cooking appliance 2000 that causes oil vapor and odors is placed, so that the portable range hood 3000 may efficiently remove oil vapor and odors.

In operation S1440, the wireless power transmission device 1000 according to an embodiment may receive height information from the cooking appliance 2000. The height information may be information about a height of the cooking appliance 2000. For example, the height information may be information about a height of an inlet part from which oil vapor is output from cooking appliance 2000. The cooking appliance 2000 may generate and transmit the height information to the wireless power transmission device 1000. The cooking appliance 2000 may include the height information in state information and may transmit the state information to the wireless power transmission device 1000. The processor 1400 of the wireless power transmission device 1000 may control the communication interface 1200 to receive the height information.

In operation S1450, the wireless power transmission device 1000 may transmit an operation command to the portable range hood 3000. The processor 1400 of the wireless power transmission device 1000 may generate the operation command, based on the height information. The operation command generated based on the height information may include a command for controlling the draw-in operation of the portable range hood 3000 by reflecting the height of the cooking appliance 2000 according to the height information. The portable range hood 3000 may receive the operation command from the wireless power transmission device 1000. The processor 3700 of the portable range hood 3000 may control the communication interface 3200 to receive the operation command from the wireless power transmission device 1000.

In operation S1460, the portable range hood 3000 may set a draw-in height. The draw-in height may be a height of an inlet via which the portable range hood 3000 draws in air. For example, the portable range hood 3000 may include a support part capable of adjusting a draw-in height of the portable range hood 3000. The processor 3700 of the portable range hood 3000 may control the support part to adjust the draw-in height, based on the operation command. For example, the processor 3700 may set the draw-in height to correspond to the height of the inlet part of the cooking appliance 2000, based on the operation command. Accordingly, it is possible to set the draw-in height of the portable range hood 3000 to correspond to the height of the inlet part of the cooking appliance 2000 that causes oil vapor and odors, so that the portable range hood 3000 may efficiently remove oil vapor and odors.

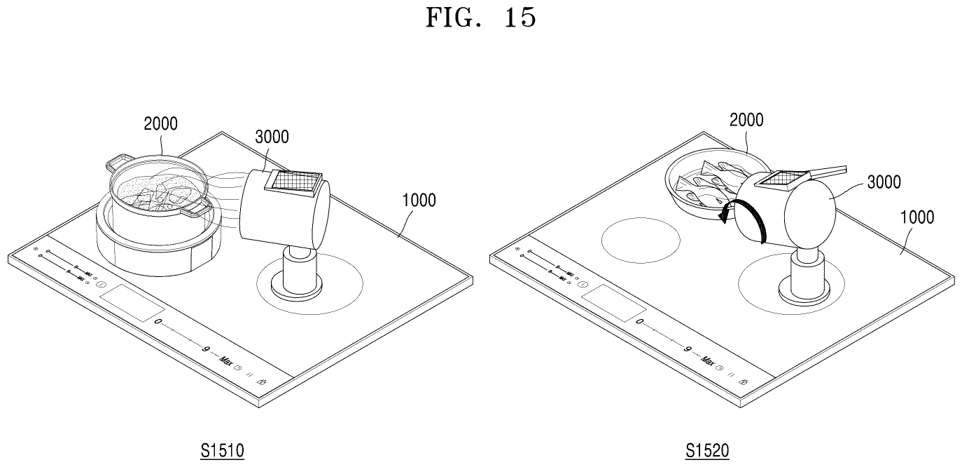

Hereinafter, an example of setting a draw-in direction and a draw-in height of the portable range hood 3000 by using an operation command, in particular, a command related to location information and height information, will now be described with reference to FIG. 15.

FIG. 15 is a diagram illustrating that the portable range hood 3000 sets a draw-in direction and a draw-in height, according to an example embodiment.

The portable range hood 3000 may further include a support part capable of adjusting at least one of a draw-in direction of the portable range hood 3000 and a height of the portable range hood 3000. For example, the support part may be a pedestal type structure capable of moving a body of the portable range hood 3000 upwardly, downwardly, leftward, or rightward.

In situation S1510, the portable range hood 3000 may be located in a first cooking zone of the wireless power transmission device 1000. The cooking appliance 2000 may be located in a second cooking zone of the wireless power transmission device 1000. The cooking appliance 2000 may be a smart pot having a first height.

In situation S1510, the processor 3700 of the portable range hood 3000 may receive an operation command from the wireless power transmission device 1000. The processor 3700 may adjust a draw-in direction of the portable range hood 3000, based on the operation command. The processor 3700 may set the draw-in direction so that the portable range hood 3000 faces the cooking appliance 2000 located in the second cooking zone. For example, the processor 3700 may adjust, based on the operation command, the draw-in direction of the portable range hood 3000 by controlling the support part of the portable range hood 3000 to face the cooking appliance 2000 located in the second cooking zone.

In situation S1510, the processor 3700 may adjust a height of the portable range hood 3000, based on the operation command. The processor 3700 may set the height of the portable range hood 3000 to correspond to a height of the cooking appliance 2000. For example, the processor 3700 may control, based on the operation command, the support part of the portable range hood 3000 so that the height of the portable range hood 3000 may correspond to a first height. Accordingly, the portable range hood 3000 may perform a draw-in operation corresponding to the location and the height of the cooking appliance 2000, and thus, may effectively remove oil vapor and odors that occur from the cooking appliance 2000.

In situation S1520, the portable range hood 3000 may be located in the first cooking zone of the wireless power transmission device 1000. The cooking appliance 2000 may be located in a third cooking zone of the wireless power transmission device 1000. Viewing from the portable range hood 3000, the third cooking zone is a cooking zone located in the right, compared to the second cooking zone. The cooking appliance 2000 may be a frying pan having a second height. The second height may be less than the first height.

In situation S1520, the processor 3700 of the portable range hood 3000 may receive an operation command from the wireless power transmission device 1000. The processor 3700 may adjust a draw-in operation of the portable range hood 3000, based on the operation command. The processor 3700 may set a draw-in direction so that the portable range hood 3000 faces the cooking appliance 2000 located in the third cooking zone. For example, the processor 3700 may rotate, based on the operation command, the draw-in direction of the portable range hood 3000 to the right by controlling the support part of the portable range hood 3000 to face the third cooking zone in which the cooking appliance 2000 is placed.

In situation S1520, the processor 3700 may adjust a height of the portable range hood 3000, based on the operation command. The processor 3700 may set the height of the portable range hood 3000 to correspond to a height of the cooking appliance 2000. For example, the processor 3700 may control, based on the operation command, the support part of the portable range hood 3000 so that the height of the portable range hood 3000 may correspond to the second height. For example, the processor 2700 may control the support part to allow the inlet of the portable range hood 3000 to face downward, so that a height of the inlet of the portable range hood 3000 may correspond to the second height. Accordingly, the portable range hood 3000 may perform a draw-in operation corresponding to the location and the height of the cooking appliance 2000, and thus, may effectively remove oil vapor and odors that occur from the cooking appliance 2000.

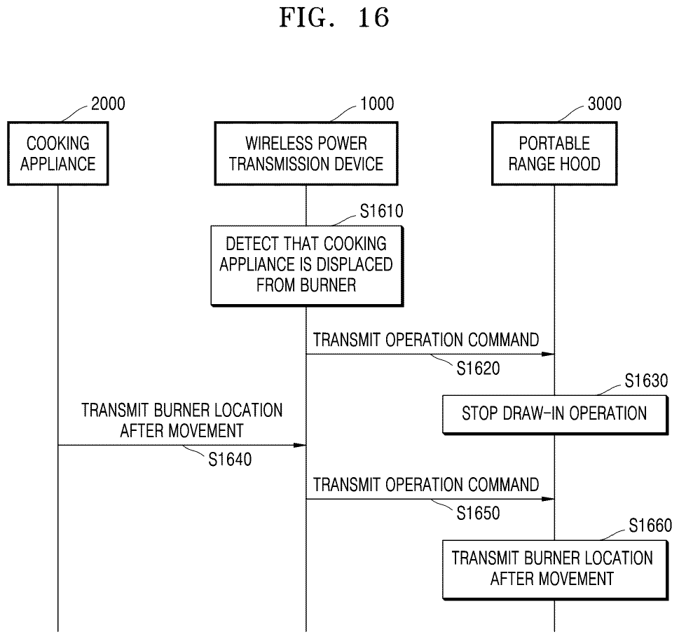

Hereinafter, a method of controlling a draw-in operation of the portable range hood 3000 by using an operation command, in particular, a command related to a cooking appliance being displaced from a burner and moved, will now be described with reference to FIG. 16.

FIG. 16 is a flowchart illustrating a draw-in operation control method of the portable range hood 3000 according to an example embodiment.

In operation S1610, the wireless power transmission device 1000 according to an embodiment may detect that the cooking appliance 2000 is displaced from a burner. The wireless power transmission device 1000 may have a plurality of burners to correspond to a plurality of cooking zones. The cooking appliance 2000 may be placed on at least one burner from among a plurality of burners. For example, the processor 1400 of the wireless power transmission device 1000 may check whether the cooking appliance 2000 is displaced from any one burner, by using the communication interface 1200 or the container detection sensor 1510. For example, when the cooking appliance 2000 is displaced from a burner, communication connection between the wireless power transmission device 1000 and the cooking appliance 2000 is released, and the processor 1400 may detect that the cooking appliance 2000 is displaced from the burner. For example, the processor 1400 may detect that the cooking appliance 2000 is displaced from the burner, based on a current change detected by the container detection sensor 1510.

In operation S1620, the wireless power transmission device 1000 according to an embodiment may transmit an operation command to the portable range hood 3000. The processor 1400 of the wireless power transmission device 1000 may generate the operation command, based on detecting burner movement of the cooking appliance 2000. The operation command generated based on detecting the burner movement of the cooking appliance 2000 may include a command for controlling a draw-in operation of the portable range hood 3000 by reflecting the burner movement of the cooking appliance 2000. The portable range hood 3000 may receive the operation command from the wireless power transmission device 1000. The processor 3700 of the portable range hood 3000 may control the communication interface 3200 to receive the operation command from the wireless power transmission device 1000.

In operation S1630, the portable range hood 3000 according to an embodiment may stop the draw-in operation. The processor 3700 of the portable range hood 3000 may control the draw-in operation, based on the operation command. When the processor 3700 receives the operation command generated based on detecting burner movement of the cooking appliance 2000, the processor 3700 may determine that the cooking appliance 2000 has been moved from any one burner. The processor 3700 may determine that the draw-in operation with respect to the any one burner is unnecessary, and may stop the draw-in operation.

In operation S1640, the cooking appliance 2000 according to an embodiment may transmit a burner location after movement to the wireless power transmission device 1000. After movement, the cooking appliance 2000 may transmit identification information to the wireless power transmission device 1000. The identification information may include location information of a burner on which it is placed after movement. The processor 1400 of the wireless power transmission device 1000 may control the communication interface 1200 to receive a burner location after movement from the cooking appliance 2000.

In operation S1650, the wireless power transmission device 1000 according to an embodiment may transmit an operation command to the portable range hood 3000. The processor 1400 of the wireless power transmission device 1000 may generate the operation command, based on the burner location after movement. The operation command generated based on the burner location after movement of the cooking appliance 2000 may include a command for controlling a draw-in operation of the portable range hood 3000 by reflecting the burner location after movement of the cooking appliance 2000. The portable range hood 3000 may receive the operation command from the wireless power transmission device 1000. The processor 3700 of the portable range hood 3000 may control the communication interface 3200 to receive the operation command from the wireless power transmission device 1000.

In operation S1660, the portable range hood 3000 according to an embodiment may resume the draw-in operation and may set a draw-in direction. The processor 3700 of the portable range hood 3000 may control the draw-in operation, based on the operation command. When the processor 3700 receives the operation command generated based on the burner location after movement of the cooking appliance 2000, the processor 3700 may determine that the draw-in operation with respect to the burner after movement of the cooking appliance 2000 is required, and may resume the draw-in operation. The processor 3700 may set the draw-in direction to face the burner after movement of the cooking appliance 2000, so as to effectively remove oil vapor and odors which occur from the cooking appliance 2000.

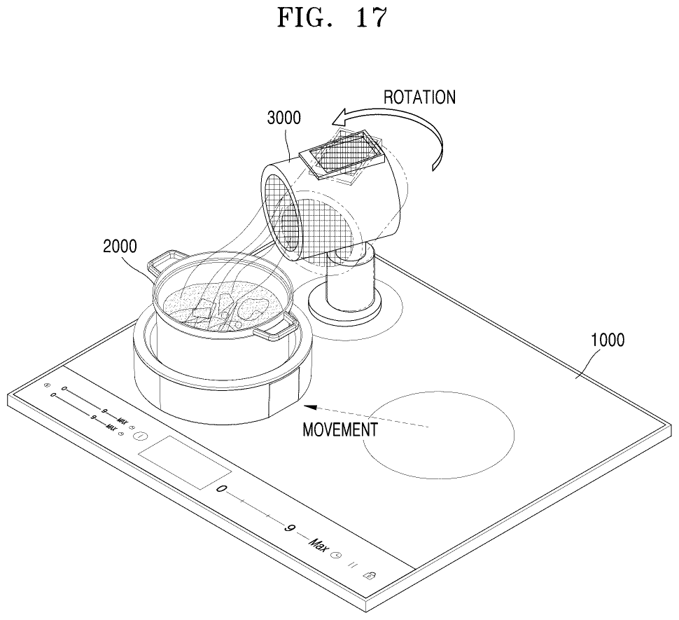

Hereinafter, an example of setting a draw-in direction of the portable range hood 3000 by using an operation command, in particular, an operation command related to burner movement of the cooking appliance 2000 will now be described with reference to FIG. 17.

FIG. 17 is a diagram illustrating that the portable range hood 3000 controls a draw-in operation according to an example embodiment.

The cooking appliance 2000 may receive power from the wireless power transmission device 1000. The cooking appliance 2000 is heated up by the received power, and thus, food in the cooking appliance 2000 may be cooked. While the food is cooked in the cooking appliance 2000, the portable range hood 3000 may perform a draw-in operation while facing the cooking appliance 2000.

The portable range hood 3000 may receive, from the wireless power transmission device 1000, an operation command related to burner movement of the cooking appliance 2000. The operation command may be a command including information indicating that the cooking appliance 2000 has been moved from any one burner to another burner. The operation command may be a command for controlling a draw-in operation after movement of the cooking appliance 2000.

The portable range hood 3000 may set a draw-in direction, based on the operation command. The portable range hood 3000 may set the draw-in direction to face the cooking appliance 2000 that has been moved to the other burner, based on the operation command related to the burner movement of the cooking appliance 2000. The portable range hood 3000 may rotate to control the portable range hood 3000 to face the cooking appliance 2000 that has been moved to the other burner. The processor 3700 of the portable range hood 3000 may rotate the support part of the portable range hood 3000 so as to control the portable range hood 3000 to face the cooking appliance 2000 that has been moved to the other burner.

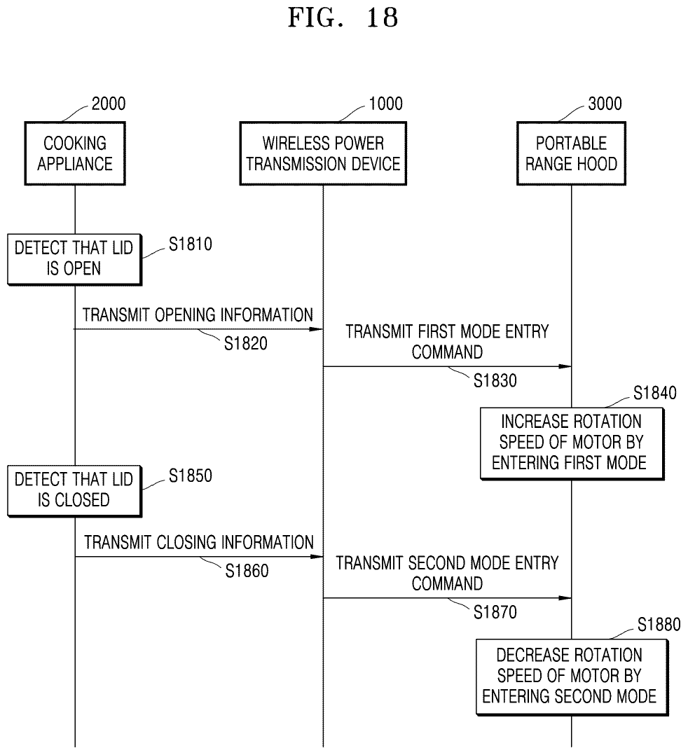

Hereinafter, a method of controlling a rotation speed of the motor 3410 of the portable range hood 3000 by using a mode entry command included in an operation command, in particular, a mode entry command related to opening and closing of a lid of the cooking appliance 2000, will now be described with reference to FIG. 18.

FIG. 18 is a flowchart illustrating that the portable range hood 3000 operates in a different mode, according to opening and closing of a lid of the cooking appliance 2000, according to an example embodiment.

In operation S1810, the cooking appliance 2000 according to an embodiment may detect that the lid is open. The cooking appliance 2000 may include a sensor configured to detect opening and closing of the lid. When the cooking appliance 2000 detects that the lid is open, the cooking appliance 2000 may generate opening information indicating that the lid of the cooking appliance 2000 is open.

In operation S1820, the cooking appliance 2000 according to an embodiment may transmit the opening information to the wireless power transmission device 1000. The processor 1400 of the wireless power transmission device 1000 may control the communication interface 1200 to receive the opening information.

In operation S1830, the wireless power transmission device 1000 according to an embodiment may transmit a first mode entry command to the portable range hood 3000. The processor 1400 of the wireless power transmission device 1000 may generate the first mode entry command, based on the opening information received from the cooking appliance 2000. The processor 1400 may determine that a lot of oil vapor and odors occur in a state in which the lid of the cooking appliance 2000 is open. The first mode entry command may be a command for allowing a draw-in operation of the portable range hood 3000 to enter a first mode by reflecting that it is a state in which the lid of the cooking appliance 2000 is open. The processor 3700 of the portable range hood 3000 may control the communication interface 3200 to receive the first mode entry command from the wireless power transmission device 1000.

In operation S1840, the portable range hood 3000 according to an embodiment may increase a rotation speed of the motor 3410 by entering the first mode. The processor 3700 of the portable range hood 3000 may enter the first mode, based on the received first mode entry command. The first mode may be a draw-in operation mode of the portable range hood 3000 so as to remove oil vapor and odors which occur a lot from the cooking appliance 2000 whose lid is open. The first mode may be a mode in which a strength of a draw-in operation is increased. The processor 3700 may increase the rotation speed of the motor 3410 so as to increase a strength of the draw-in operation.

In operation S1850, the cooking appliance 2000 according to an embodiment may detect that the lid is closed. The cooking appliance 2000 may include a sensor configured to detect opening and closing of the lid. When the cooking appliance 2000 detects that the lid is closed, the cooking appliance 2000 may generate closing information indicating that the lid of the cooking appliance 2000 is closed.

In operation S1860, the cooking appliance 2000 according to an embodiment may transmit the closing information to the wireless power transmission device 1000. The processor 1400 of the wireless power transmission device 1000 may control the communication interface 1200 to receive the closing information.

In operation S1870, the wireless power transmission device 1000 according to an embodiment may transmit a second mode entry command to the portable range hood 3000. The processor 1400 of the wireless power transmission device 1000 may generate the second mode entry command, based on the closing information received from the cooking appliance 2000. The processor 1400 may determine that fewer oil vapor and odors occur in a state in which the lid of the cooking appliance 2000 is closed. The second mode entry command may be a command for allowing a draw-in operation of the portable range hood 3000 to enter a second mode by reflecting that it is a state in which the lid of the cooking appliance 2000 is closed. The processor 3700 of the portable range hood 3000 may control the communication interface 3200 to receive the second mode entry command from the wireless power transmission device 1000.

In operation S1880, the portable range hood 3000 according to an embodiment may decrease a rotation speed of the motor 3410 by entering the second mode. The processor 3700 of the portable range hood 3000 may enter the second mode, based on the received second mode entry command. The second mode may be a draw-in operation mode of the portable range hood 3000 so as to remove oil vapor and odors which occur less from the cooking appliance 2000 whose lid is closed. The second mode may be a mode in which a strength of a draw-in operation is decreased. The processor 3700 may decrease the rotation speed of the motor 3410 so as to decrease a strength of the draw-in operation.

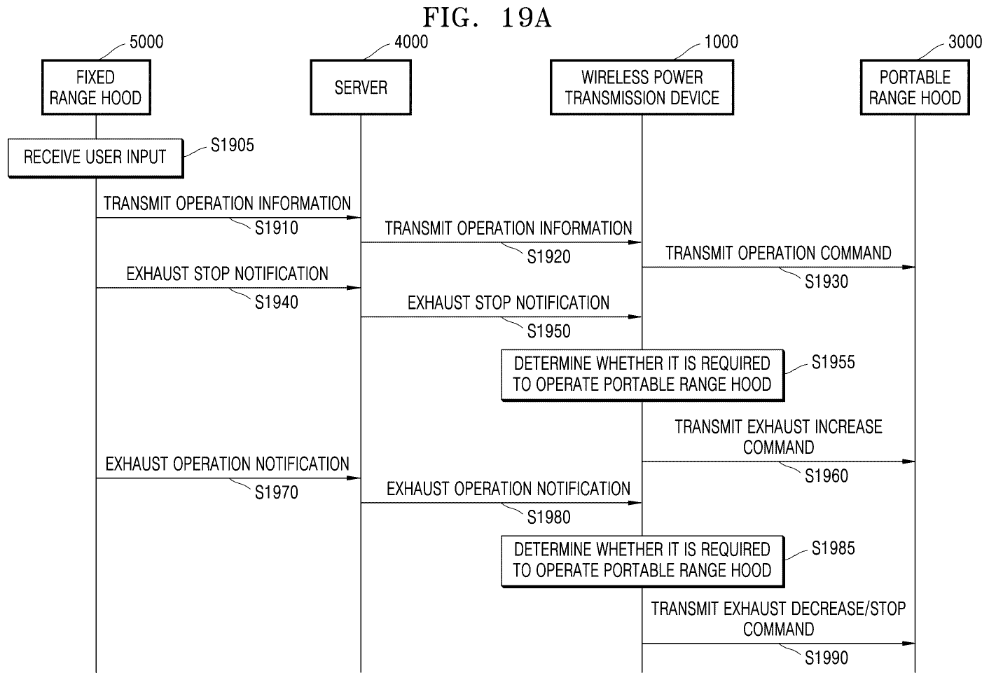

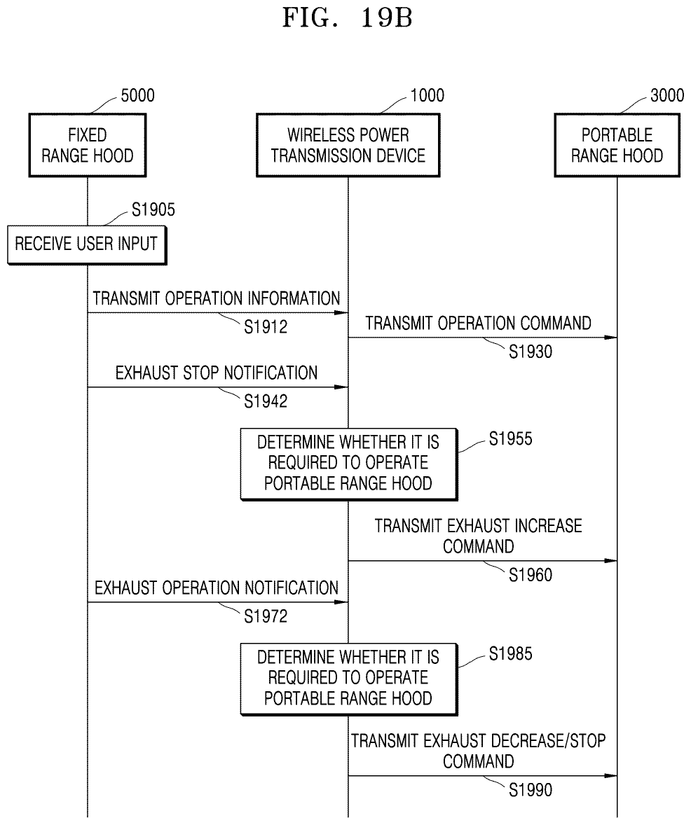

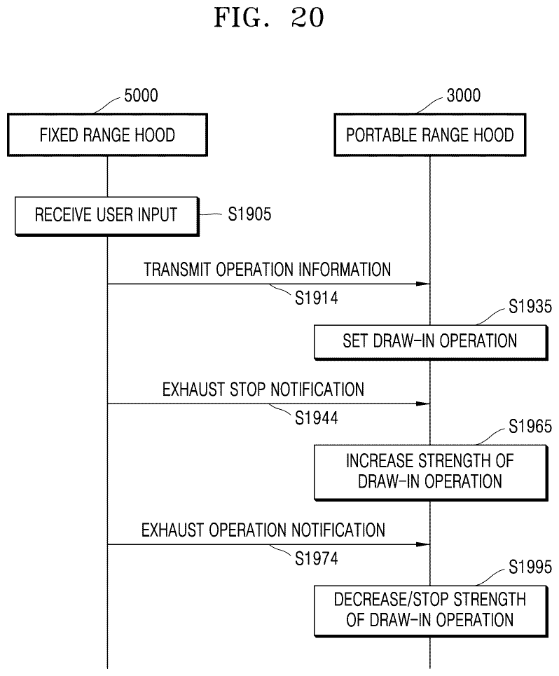

Hereinafter, a method of setting a draw-in operation and exhaust of the portable range hood 3000, based on an operation command, in particular, operation information of a fixed range hood 5000, in a system including the fixed range hood 5000, will now be described with reference to FIGS. 19A, 19B, and 20. The fixed range hood 5000 may be installed at the wall or the ceiling of the house.

FIG. 19A is a flowchart illustrating that the portable range hood 3000 operates based on the operation information of the fixed range hood 5000, according to an example embodiment. Referring to FIG. 19A, the fixed range hood 5000 may establish wireless communication connection to a server 4000.

In operation S1905, the fixed range hood 5000 according to an embodiment may receive a user input. The user input may be an input for controlling an operation of the fixed range hood 5000. For example, the user input may include an input of starting a draw-in operation and an exhaust operation of the fixed range hood 5000, an input of stopping the draw-in operation and the exhaust operation, and an input of adjusting a strength of the draw-in operation and the exhaust operation.

In operation S1910, the fixed range hood 5000 according to an embodiment may transmit the operation information to the server 4000. The operation information may include information related to whether to perform the draw-in operation and the exhaust operation of the fixed range hood 5000 and a strength of the draw-in operation and the exhaust operation. The server 4000 may receive the operation information from the fixed range hood 5000.

In operation S1920, the server 4000 according to an embodiment may transmit the operation information to the wireless power transmission device 1000. The server 4000 may establish wireless communication connection of the wireless power transmission device 1000. The server 4000 may transmit, to the wireless power transmission device 1000, the operation information received from the fixed range hood 5000. The processor 1400 of the wireless power transmission device 1000 may control the communication interface 1200 to receive the operation information of the fixed range hood 5000 from the server 4000.

In operation S1930, the wireless power transmission device 1000 according to an embodiment may transmit an operation command to the portable range hood 3000. The processor 1400 of the wireless power transmission device 1000 may generate the operation command, based on the operation information of the fixed range hood 5000. The processor 1400 may determine whether it is required to operate the portable range hood 3000, based on the operation information of the fixed range hood 5000. The operation command generated based on the operation information of the fixed range hood 5000 may include a command for controlling a draw-in operation of the portable range hood 3000 by reflecting an operation state of the fixed range hood 5000. The portable range hood 3000 may receive the operation command from the wireless power transmission device 1000. The processor 3700 of the portable range hood 3000 may control the communication interface 3200 to receive the operation command from the wireless power transmission device 1000. The processor 3700 may control the draw-in operation and exhaust of the portable range hood 3000, based on the operation command.

In operation S1940, the fixed range hood 5000 according to an embodiment may transmit an exhaust stop notification to the server 4000. The exhaust stop notification may be a signal for informing that a draw-in operation and exhaust of the fixed range hood 5000 are stopped. The server 4000 may receive the exhaust stop notification from the fixed range hood 5000.

In operation S1950, the server 4000 according to an embodiment may transmit the exhaust stop notification to the wireless power transmission device 1000. The server 4000 may transmit the exhaust stop notification received from the fixed range hood 5000 to the wireless power transmission device 1000. The processor 1400 of the wireless power transmission device 1000 may control the communication interface 1200 to receive the exhaust stop notification of the fixed range hood 5000 from the server 4000.

In operation S1955, the wireless power transmission device 1000 according to an embodiment may determine whether it is required to operate the portable range hood 3000. The processor 1400 of the wireless power transmission device 1000 may determine whether it is required to operate the portable range hood 3000, based on an exhaust state of the fixed range hood 5000. The processor 1400 of the wireless power transmission device 1000 may determine that it is required to operate the portable range hood 3000, based on an exhaust stop state of the fixed range hood 5000.

In operation S1960, the wireless power transmission device 1000 according to an embodiment may transmit an exhaust increase command to the portable range hood 3000. The processor 1400 of the wireless power transmission device 1000 may generate the exhaust increase command, based on determination on an operation necessity with respect to the portable range hood 3000. The exhaust increase command generated based on determination on the operation necessity with respect to the portable range hood 3000 may include a command for increasing the draw-in operation and exhaust of the portable range hood 3000 by reflecting the operation state of the fixed range hood 5000. The portable range hood 3000 may receive the exhaust increase command from the wireless power transmission device 1000. The processor 3700 of the portable range hood 3000 may control the communication interface 3200 to receive the exhaust increase command from the wireless power transmission device 1000. The processor 3700 may increase the draw-in operation and exhaust of the portable range hood 3000, based on the exhaust increase command. Accordingly, when the fixed range hood 5000 stops exhaust, the processor 3700 may increase exhaust of the portable range hood 3000, and thus, may remove oil vapor and odors which occur from the cooking appliance 2000.

In operation S1970, the fixed range hood 5000 according to an embodiment may transmit an exhaust operation notification to the server 4000. The exhaust operation notification may be a signal for informing that a draw-in operation and an exhaust operation of the fixed range hood 5000 start. The server 4000 may receive the exhaust operation notification from the fixed range hood 5000.

In operation S1980, the server 4000 according to an embodiment may transmit the exhaust operation notification to the wireless power transmission device 1000. The server 4000 may transmit, to the wireless power transmission device 1000, the exhaust operation notification received from the fixed range hood 5000. The processor 1400 of the wireless power transmission device 1000 may control the communication interface 1200 to receive the exhaust operation notification of the fixed range hood 5000 from the server 4000.

In operation S1985, the wireless power transmission device 1000 according to an embodiment may determine whether it is required to operate the portable range hood 3000. The processor 1400 of the wireless power transmission device 1000 may determine whether it is required to operate the portable range hood 3000, based on an exhaust state of the fixed range hood 5000. The processor 1400 of the wireless power transmission device 1000 may determine that a necessity to operate the portable range hood 3000 based on an exhaust operation state of the fixed range hood 5000 is decreased.

In operation S1990, the wireless power transmission device 1000 according to an embodiment may transmit an exhaust decrease command or an exhaust stop command to the portable range hood 3000. The processor 1400 of the wireless power transmission device 1000 may generate the exhaust decrease command or the exhaust stop command, based on determination on an operation necessity with respect to the portable range hood 3000. The exhaust decrease command or the exhaust stop command generated based on the determination on the operation necessity with respect to the portable range hood 3000 may include a command for decreasing or stopping the draw-in operation and exhaust of the portable range hood 3000 by reflecting the operation state of the fixed range hood 5000. The portable range hood 3000 may receive the exhaust decrease command or the exhaust stop command from the wireless power transmission device 1000. The processor 3700 of the portable range hood 3000 may control the communication interface 3200 to receive the exhaust decrease command or the exhaust stop command from the wireless power transmission device 1000. The processor 3700 may decrease or stop the draw-in operation and exhaust of the portable range hood 3000, based on the exhaust decrease command or the exhaust stop command. Accordingly, when the fixed range hood 5000 performs the exhaust operation, the fixed range hood 5000 may remove oil vapor and odors which occur from the cooking appliance 2000, and thus, the processor 3700 may decrease or stop the draw-in operation and exhaust of the portable range hood 3000.

FIG. 19B is a flowchart illustrating that the portable range hood 3000 operates based on operation information of the fixed range hood 5000, according to an example embodiment. Referring to FIG. 19B, the fixed range hood 5000 may establish wireless communication connection to the wireless power transmission device 1000. When the fixed range hood 5000 establishes wireless communication connection to the wireless power transmission device 1000, the fixed range hood 5000 may transmit information to the wireless power transmission device 1000 without passing through the server 4000.

In operation S1905, the fixed range hood 5000 according to an embodiment may receive a user input. The user input may be an input for controlling an operation of the fixed range hood 5000. For example, the user input may include an input of starting a draw-in operation and an exhaust operation of the fixed range hood 5000, an input of stopping the draw-in operation and the exhaust operation, and an input of adjusting a strength of the draw-in operation and the exhaust operation.

In operation S1912, the fixed range hood 5000 according to an embodiment may transmit operation information to the wireless power transmission device 1000. The operation information may include information related to whether to perform the draw-in operation and the exhaust operation of the fixed range hood 5000 and a strength of the draw-in operation and the exhaust operation. The wireless power transmission device 1000 may receive the operation information from the fixed range hood 5000. The processor 1400 of the wireless power transmission device 1000 may control the communication interface 1200 to receive the operation information of the fixed range hood 5000 from the fixed range hood 5000.

In operation S1930, the wireless power transmission device 1000 according to an embodiment may transmit an operation command to the portable range hood 3000. The processor 1400 of the wireless power transmission device 1000 may generate the operation command, based on the operation information of the fixed range hood 5000. The processor 1400 may determine whether it is required to operate the portable range hood 3000, based on the operation information of the fixed range hood 5000. The operation command generated based on the operation information of the fixed range hood 5000 may include a command for controlling a draw-in operation of the portable range hood 3000 by reflecting an operation state of the fixed range hood 5000. The portable range hood 3000 may receive the operation command from the wireless power transmission device 1000. The processor 3700 of the portable range hood 3000 may control the communication interface 3200 to receive the operation command from the wireless power transmission device 1000. The processor 3700 may control the draw-in operation and exhaust of the portable range hood 3000, based on the operation command.

In operation S1942, the fixed range hood 5000 according to an embodiment may transmit an exhaust stop notification to the wireless power transmission device 1000. The exhaust stop notification may be a signal for informing that a draw-in operation and exhaust of the fixed range hood 5000 are stopped. The wireless power transmission device 1000 may receive the exhaust stop notification from the fixed range hood 5000. The processor 1400 of the wireless power transmission device 1000 may control the communication interface 1200 to receive the exhaust stop notification of the fixed range hood 5000 from the server 4000.

In operation S1955, the wireless power transmission device 1000 according to an embodiment may determine whether it is required to operate the portable range hood 3000. The processor 1400 of the wireless power transmission device 1000 may determine whether it is required to operate the portable range hood 3000, based on an exhaust state of the fixed range hood 5000. The processor 1400 of the wireless power transmission device 1000 may determine that it is required to operate the portable range hood 3000, based on an exhaust stop state of the fixed range hood 5000.

In operation S1960, the wireless power transmission device 1000 according to an embodiment may transmit an exhaust increase command to the portable range hood 3000. The processor 1400 of the wireless power transmission device 1000 may generate the exhaust increase command, based on determination on an operation necessity with respect to the portable range hood 3000. The exhaust increase command generated based on determination on the operation necessity with respect to the portable range hood 3000 may include a command for increasing the draw-in operation and exhaust of the portable range hood 3000 by reflecting the operation state of the fixed range hood 5000. The portable range hood 3000 may receive the exhaust increase command from the wireless power transmission device 1000. The processor 3700 of the portable range hood 3000 may control the communication interface 3200 to receive the exhaust increase command from the wireless power transmission device 1000. The processor 3700 may increase the draw-in operation and exhaust of the portable range hood 3000, based on the exhaust increase command. Accordingly, when the fixed range hood 5000 stops exhaust, the processor 3700 may increase exhaust of the portable range hood 3000, and thus, may remove oil vapor and odors which occur from the cooking appliance 2000.

In operation S1972, the fixed range hood 5000 according to an embodiment may transmit an exhaust operation notification to the wireless power transmission device 1000. The exhaust operation notification may be a signal for informing that a draw-in operation and an exhaust operation of the fixed range hood 5000 start. The wireless power transmission device 1000 may receive the exhaust operation notification from the fixed range hood 5000. The processor 1400 of the wireless power transmission device 1000 may control the communication interface 1200 to receive the exhaust operation notification of the fixed range hood 5000 from the server 4000.

In operation S1985, the wireless power transmission device 1000 according to an embodiment may determine whether it is required to operate the portable range hood 3000. The processor 1400 of the wireless power transmission device 1000 may determine whether it is required to operate the portable range hood 3000, based on an exhaust state of the fixed range hood 5000. The processor 1400 of the wireless power transmission device 1000 may determine that a necessity to operate the portable range hood 3000 based on an exhaust operation state of the fixed range hood 5000 is decreased.

In operation S1990, the wireless power transmission device 1000 according to an embodiment may transmit an exhaust decrease command or an exhaust stop command to the portable range hood 3000. The processor 1400 of the wireless power transmission device 1000 may generate the exhaust decrease command or the exhaust stop command, based on determination on an operation necessity with respect to the portable range hood 3000. The exhaust decrease command or the exhaust stop command generated based on the determination on the operation necessity with respect to the portable range hood 3000 may include a command for decreasing or stopping the draw-in operation and exhaust of the portable range hood 3000 by reflecting the operation state of the fixed range hood 5000. The portable range hood 3000 may receive the exhaust decrease command or the exhaust stop command from the wireless power transmission device 1000. The processor 3700 of the portable range hood 3000 may control the communication interface 3200 to receive the exhaust decrease command or the exhaust stop command from the wireless power transmission device 1000. The processor 3700 may decrease or stop the draw-in operation and exhaust of the portable range hood 3000, based on the exhaust decrease command or the exhaust stop command. Accordingly, when the fixed range hood 5000 performs the exhaust operation, the fixed range hood 5000 may remove oil vapor and odors which occur from the cooking appliance 2000, and thus, the processor 3700 may decrease or stop the draw-in operation and exhaust of the portable range hood 3000.

FIG. 20 is a flowchart illustrating that the portable range hood 3000 operates based on operation information of the fixed range hood 5000, according to an example embodiment. Referring to FIG. 20, the fixed range hood 5000 may establish wireless communication connection to the portable range hood 3000. When the fixed range hood 5000 establishes wireless communication connection to the portable range hood 3000, the fixed range hood 5000 may transmit information to the portable range hood 3000 without passing through the server 4000 and the wireless power transmission device 1000.

In operation S1905, the fixed range hood 5000 according to an embodiment may receive a user input. The user input may be an input for controlling an operation of the fixed range hood 5000. For example, the user input may include an input of starting a draw-in operation and an exhaust operation of the fixed range hood 5000, an input of stopping the draw-in operation and the exhaust operation, and an input of adjusting a strength of the draw-in operation and the exhaust operation.

In operation S1914, the fixed range hood 5000 according to an embodiment may transmit operation information to the portable range hood 3000. The operation information may include information related to whether to perform the draw-in operation and the exhaust operation of the fixed range hood 5000 and a strength of the draw-in operation and the exhaust operation. The portable range hood 3000 may receive the operation information from the fixed range hood 5000. The processor 3700 of the portable range hood 3000 may control the communication interface 3200 to receive the operation information of the fixed range hood 5000 from the fixed range hood 5000.

In operation S1935, the portable range hood 3000 according to an embodiment may set a draw-in operation. The processor 3700 of the portable range hood 3000 may set the draw-in operation of the driving unit 3400 of the portable range hood 3000, based on the operation information of the fixed range hood 5000. The processor 3700 may determine whether it is required for the driving unit 3400 to perform the draw-in operation, based on the operation information of the fixed range hood 5000. The processor 3700 may control a draw-in operation and exhaust of the portable range hood 3000 by reflecting an operation state of the fixed range hood 5000.

In operation S1944, the fixed range hood 5000 according to an embodiment may transmit an exhaust stop notification to the portable range hood 3000. The exhaust stop notification may be a signal for informing that a draw-in operation and exhaust of the fixed range hood 5000 are stopped. The portable range hood 3000 may receive the exhaust stop notification from the fixed range hood 5000. The processor 3700 of the portable range hood 3000 may control the communication interface 3200 to receive the exhaust stop notification of the fixed range hood 5000 from the fixed range hood 5000.

In operation S1965, the portable range hood 3000 according to an embodiment may increase a strength of the draw-in operation. The processor 3700 of the portable range hood 3000 may increase the strength of the draw-in operation and exhaust, based on the exhaust stop notification of the fixed range hood 5000. Accordingly, when the fixed range hood 5000 stops exhaust, the processor 3700 may increase the strength of the draw-in operation and exhaust of the portable range hood 3000, and thus, may remove oil vapor and odors which occur from the cooking appliance 2000.

In operation S1974, the fixed range hood 5000 according to an embodiment may transmit an exhaust operation notification to the portable range hood 3000. The exhaust operation notification may be a signal for informing that a draw-in operation and an exhaust operation of the fixed range hood 5000 start. The portable range hood 3000 may receive the exhaust operation notification from the fixed range hood 5000. The processor 3700 of the portable range hood 3000 may control the communication interface 3200 to receive the exhaust operation notification of the fixed range hood 5000 from the fixed range hood 5000.

In operation S1995, the portable range hood 3000 according to an embodiment may decrease or stop a strength of the draw-in operation. The processor 3700 of the portable range hood 3000 may decrease or stop the strength of the draw-in operation and exhaust, based on the exhaust operation notification of the fixed range hood 5000. Accordingly, when the fixed range hood 5000 performs the exhaust operation, the fixed range hood 5000 may remove oil vapor and odors which occur from the cooking appliance 2000, and thus, the processor 3700 may decrease or stop the draw-in operation and exhaust of the portable range hood 3000.

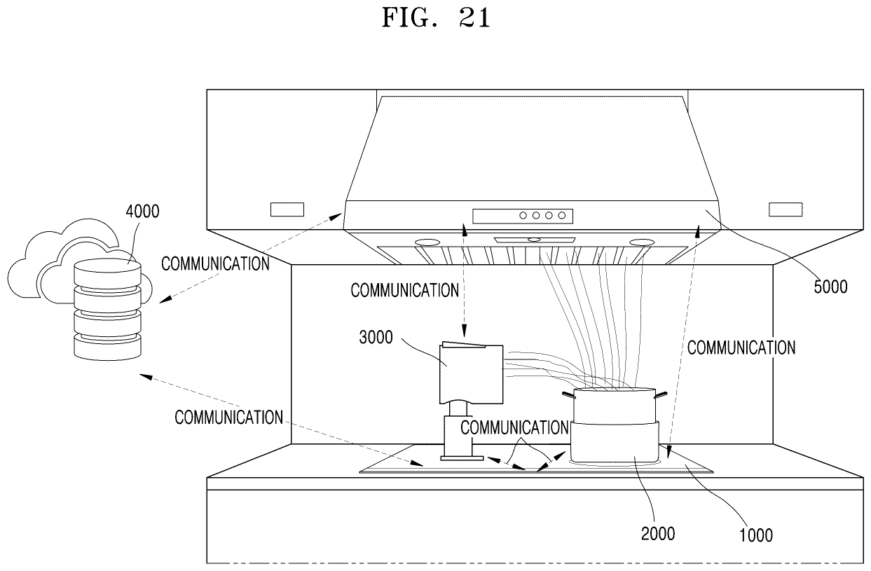

Hereinafter, an example of setting a draw-in operation and exhaust of the portable range hood 3000, based on an operation command, in particular, operation information of the fixed range hood 5000, in a system including the fixed range hood 5000, will now be described with reference to FIG. 21.

FIG. 21 is a diagram illustrating an example in which the portable range hood 3000 operates based on operation information of the fixed range hood 5000, according to an example embodiment.

The fixed range hood 5000 may be installed at the wall or the ceiling of the house. The fixed range hood 5000 may be installed above the wireless power transmission device 1000. The fixed range hood 5000 may remove oil vapor and odors which occur from the cooking appliance 2000. The fixed range hood 5000 may establish wireless communication connection to the wireless power transmission device 1000 or the portable range hood 3000. For example, as described with reference to FIG. 19A, the fixed range hood 5000 may establish wireless communication connection to the server 4000. For example, as described with reference to FIG. 19B, the fixed range hood 5000 may establish wireless communication connection to the wireless power transmission device 1000. For example, as described with reference to FIG. 20, the fixed range hood 5000 may establish wireless communication connection to the portable range hood 3000.

The processor 3700 of the portable range hood 3000 may adjust a draw-in operation and exhaust of the portable range hood 3000, based on operation information of the fixed range hood 5000. When an operation of the fixed range hood 5000 is stopped, the processor 3700 may increase the draw-in operation and exhaust of the portable range hood 3000. When an operation of the fixed range hood 5000 starts, the processor 3700 may decrease or stop the draw-in operation and exhaust of the portable range hood 3000. Accordingly, when it is insufficient for the fixed range hood 5000 to remove oil vapor or odors which occur from the cooking appliance 2000, the oil vapor or the odors which occur from the cooking appliance 2000 may be removed by using the portable range hood 3000.

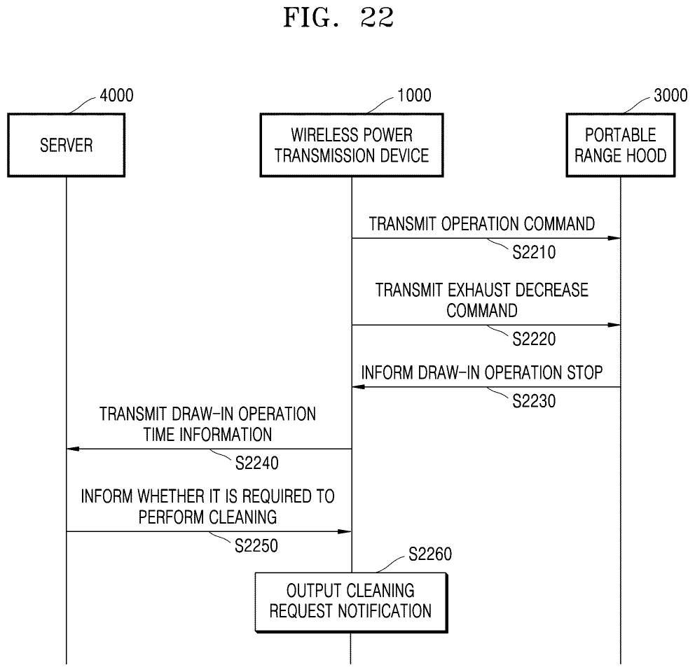

When the portable range hood 3000 operates for a preset time or more, oil vapor and odors may be accumulated in the fan 3420 of the portable range hood 3000, the at least one filter 3600 included in the portable range hood 3000, and the portable range hood 3000. Hereinafter, a method by which the wireless power transmission device 1000 displays a notification indicating a necessity to clean the portable range hood 3000 will now be described with reference to FIG. 22.

FIG. 22 is a flowchart illustrating that the wireless power transmission device 1000 outputs a cleaning request notification with respect to the portable range hood 3000, according to an example embodiment.

In operation S2210, the wireless power transmission device 1000 according to an embodiment may transmit an operation command to the portable range hood 3000. The operation command may be a command for controlling a draw-in operation and exhaust of the portable range hood 3000. The portable range hood 3000 may receive the operation command from the wireless power transmission device 1000. The portable range hood 3000 may perform the draw-in operation and exhaust, based on the operation command.

In operation S2220, the wireless power transmission device 1000 according to an embodiment may transmit an exhaust decrease command to the portable range hood 3000. The exhaust decrease command may be a command for decreasing or stopping the draw-in operation and exhaust of the portable range hood 3000. The portable range hood 3000 may receive the exhaust decrease command from the wireless power transmission device 1000. The portable range hood 3000 may decrease or stop the draw-in operation and exhaust, based on the exhaust decrease command.

In operation S2230, the portable range hood 3000 according to an embodiment may inform a draw-in operation stop to the wireless power transmission device 1000. The processor 3700 of the portable range hood 3000 may control the communication interface 3200 to transmit, to the wireless power transmission device 1000, a signal for informing that the portable range hood 3000 has stopped the draw-in operation and exhaust.

In operation S2240, the wireless power transmission device 1000 according to an embodiment may transmit draw-in operation time information to the server 4000. The draw-in operation time information may include information about a duration time in which the portable range hood 3000 performed the draw-in operation. The processor 1400 of the wireless power transmission device 1000 may calculate the duration time in which the portable range hood 3000 performed the draw-in operation, based on a point in time at which a notification of the draw-in operation stop is received from the portable range hood 3000. The processor 1400 may control the communication interface 1200 to transmit the draw-in operation time information to the server 4000.

In operation S2250, the server 400 according to an embodiment may inform, to the wireless power transmission device 1000, whether it is required to perform cleaning. The server 4000 may store information about whether it is required to perform cleaning with respect to the portable range hood 3000, according to a duration time of the draw-in operation by the portable range hood 3000. The server 4000 may receive draw-in operation time information of the portable range hood 3000, and may determine whether it is required to clean the portable range hood 3000. The wireless power transmission device 1000 may receive, from the server 4000, a notification about whether it is required to perform cleaning.

In operation S2260, the wireless power transmission device 1000 according to an embodiment may output a cleaning request notification. When a notification received from the server 4000 corresponds to a notification indicating that cleaning of the portable range hood 3000 is required, the wireless power transmission device 1000 may output the cleaning request notification. The processor 1400 of the wireless power transmission device 1000 may control the output interface 1310 to output the cleaning request notification. For example, the processor 1400 may control the display unit of the output interface 1310 to visually output the notification indicating cleaning is required. For example, the processor 1400 may control the sound output unit of the output interface 1310 to output a voice notification indicating cleaning is required.

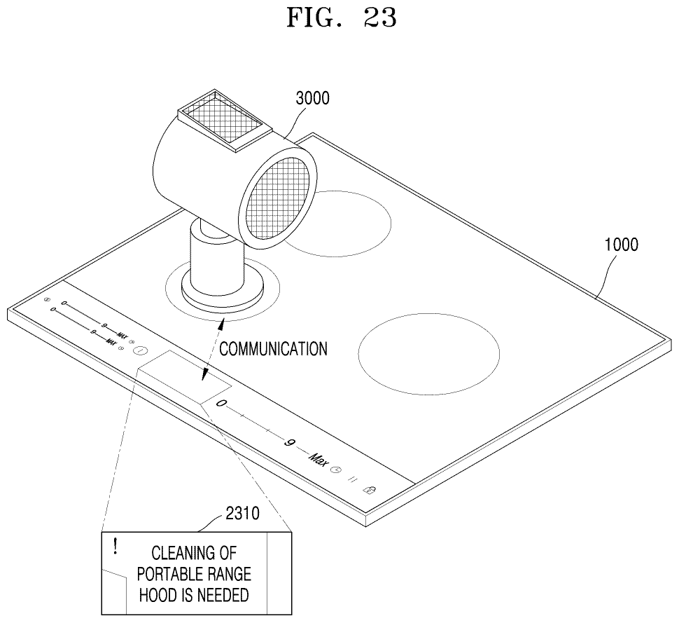

Hereinafter, an example in which a notification indicating that cleaning of the portable range hood 3000 is required is displayed by the wireless power transmission device 1000 will now be described with reference to FIG. 23.

FIG. 23 illustrates an example in which the wireless power transmission device 1000 outputs a cleaning request notification 2310 with respect to the portable range hood 3000, according to an example embodiment.

The portable range hood 3000 and the wireless power transmission device 1000 may establish wireless communication connection. The portable range hood 3000 may receive a command to stop an operation from the wireless power transmission device 1000. The portable range hood 3000 may stop a draw-in operation, based on the command to stop the operation. When cooking by the cooking appliance 2000 is completed or the cooking appliance 2000 is displaced from the wireless power transmission device 1000, the portable range hood 3000 may stop the draw-in operation. The portable range hood 3000 may inform the wireless power transmission device 1000 with a stop of the draw-in operation.

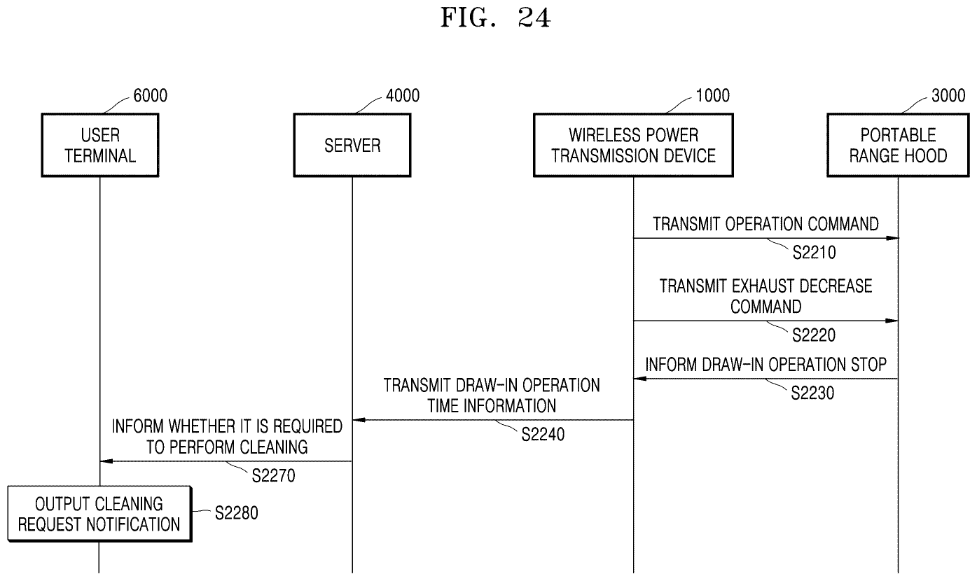

The wireless power transmission device 1000 may transmit draw-in operation time information to the server 4000. The wireless power transmission device 1000 may receive, from the server 4000, a notification about whether it is required to perform cleaning. When a notification received from the server 4000 corresponds to a notification indicating that cleaning of the portable range hood 3000 is required, the wireless power transmission device 1000 may output the cleaning request notification 2310. The cleaning request notification 2310 may include a message “Cleaning of the portable range hood 3000 is needed”. A user may identify, via the cleaning request notification 2310, that cleaning of the portable range hood 3000 is required. Hereinafter, a method by which a user terminal 6000 displays a notification indicating that cleaning of the portable range hood 3000 is required will now be described with reference to FIG. 24.

FIG. 24 is a flowchart illustrating that the user terminal 6000 outputs a cleaning request notification with respect to the portable range hood 3000, according to an example embodiment. Referring to FIG. 24, the server 4000 may be connected, directly or indirectly, to the user terminal 6000. The user terminal 6000 may be a mobile terminal carried by a user. For example, the user terminal 6000 may be a portable communication device such as a smartphone.

In operation S2210, the wireless power transmission device 1000 according to an embodiment may transmit an operation command to the portable range hood 3000. The operation command may be a command for controlling a draw-in operation and exhaust of the portable range hood 3000. The portable range hood 3000 may receive the operation command from the wireless power transmission device 1000. The portable range hood 3000 may perform the draw-in operation and exhaust, based on the operation command.

In operation S2220, the wireless power transmission device 1000 according to an embodiment may transmit an exhaust decrease command to the portable range hood 3000. The exhaust decrease command may be a command for decreasing or stopping the draw-in operation and exhaust of the portable range hood 3000. The portable range hood 3000 may receive the exhaust decrease command from the wireless power transmission device 1000. The portable range hood 3000 may decrease or stop the draw-in operation and exhaust, based on the exhaust decrease command.

In operation S2230, the portable range hood 3000 according to an embodiment may inform a draw-in operation stop to the wireless power transmission device 1000. The processor 3700 of the portable range hood 3000 may control the communication interface 3200 to transmit, to the wireless power transmission device 1000, a signal for informing that the portable range hood 3000 has stopped the draw-in operation and exhaust.

In operation S2240, the wireless power transmission device 1000 according to an embodiment may transmit draw-in operation time information to the server 4000. The draw-in operation time information may include information about a duration time in which the portable range hood 3000 performed the draw-in operation. The processor 1400 of the wireless power transmission device 1000 may calculate the duration time in which the portable range hood 3000 performed the draw-in operation, based on a point in time at which a notification of the draw-in operation stop is received from the portable range hood 3000. The processor 1400 may control the communication interface 1200 to transmit the draw-in operation time information to the server 4000.

In operation S2270, the server 400 according to an embodiment may inform, to the user terminal 6000, whether it is required to perform cleaning. The server 4000 may store information about whether it is required to perform cleaning with respect to the portable range hood 3000, according to a duration time of the draw-in operation by the portable range hood 3000. The server 4000 may receive draw-in operation time information of the portable range hood 3000, and may determine whether it is required to clean the portable range hood 3000. The user terminal 6000 may receive, from the server 4000, a notification about whether it is required to perform cleaning.

In operation S2280, the user terminal 6000 according to an embodiment may output a cleaning request notification. When a notification received from the server 4000 corresponds to a notification indicating that cleaning of the portable range hood 3000 is required, the user terminal 6000 may output the cleaning request notification. The user terminal 6000 may control an output interface to output the cleaning request notification. For example, the user terminal 6000 may control a display unit of the output interface to visually output the notification indicating cleaning is required. For example, the user terminal 6000 may control a sound output unit of the output interface to output a voice notification indicating cleaning is required.

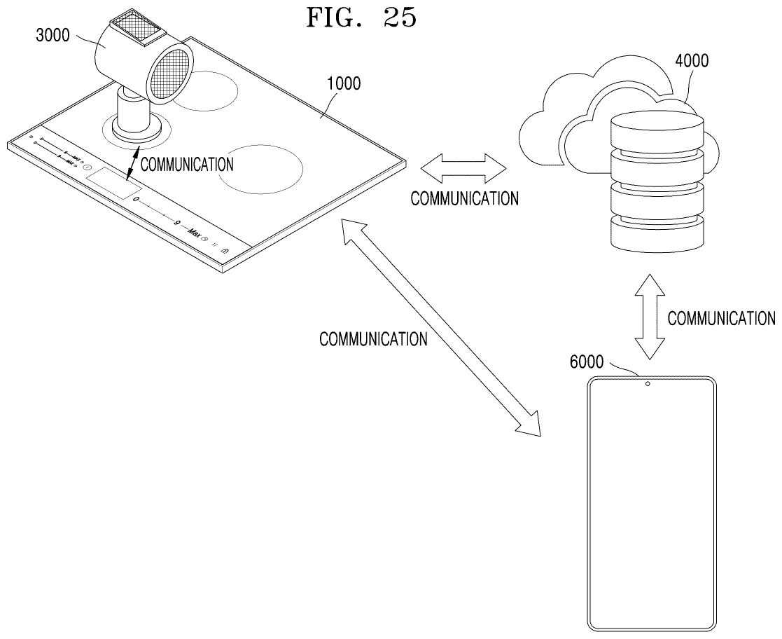

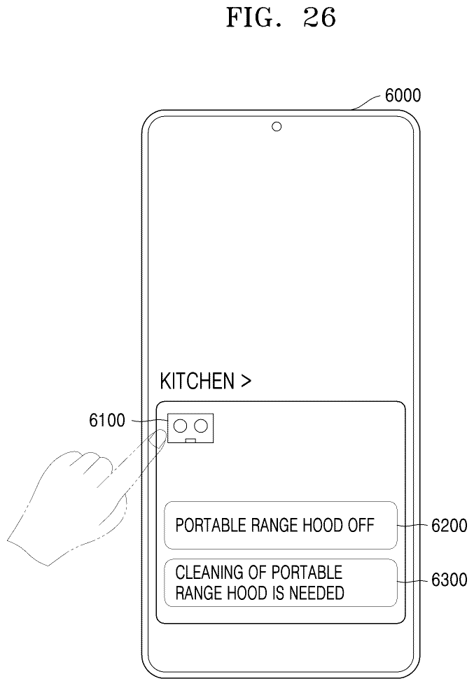

Hereinafter, an example in which a notification indicating that cleaning of the portable range hood 3000 is required is displayed by the user terminal 6000 will now be described with reference to FIGS. 25 and 26.

FIG. 25 is a diagram illustrating a system including a user terminal according to an example embodiment.

The wireless power transmission device 1000 and the portable range hood 3000 may establish wireless communication connection. The wireless power transmission device 1000, the server 4000, and the user terminal 6000 may establish wireless communication connection. The wireless power transmission device 1000, the portable range hood 3000, and the user terminal 6000 may be connected to the server 4000 via a WAN. The AP may communicate with the wireless power transmission device 1000, the portable range hood 3000, or the user terminal 6000 by using wireless communication such as Wi-Fi™ (IEEE 802.11), etc., and may access the WAN by using wired communication.

The portable range hood 3000 may receive a command to stop an operation from the wireless power transmission device 1000. The portable range hood 3000 may stop a draw-in operation, based on the command to stop the operation. When cooking by the cooking appliance 2000 is completed or the cooking appliance 2000 is displaced from the wireless power transmission device 1000, the portable range hood 3000 may stop the draw-in operation. The portable range hood 3000 may inform the wireless power transmission device 1000 with a stop of the draw-in operation. The wireless power transmission device 1000 may transmit draw-in operation time information to the server 4000.

FIG. 26 illustrates an example in which the user terminal 6000 outputs a cleaning request notification with respect to the portable range hood 3000, according to an example embodiment.

The user terminal 6000 may establish long-range communication connection (e.g.: WiFi communication) to the wireless power transmission device 1000 via the server 4000. The user terminal 6000 may display an icon 6100 indicating the wireless power transmission device 1000 registered in the server 4000 via a user account equal to the user terminal 6000, via an execution window of a particular application (e.g., a home appliance management application). The user terminal 6000 may display an icon 6200 indicating the portable range hood 3000 registered in the server 4000 via the user account equal to the user terminal 6000. Here, the user terminal 6000 may display an operation state (e.g.: working or off) of the portable range hood 3000. For example, the user terminal 6000 may receive information indicating that the portable range hood 3000 is working from the wireless power transmission device 1000 via the server 4000, and may display the information indicating that the portable range hood 3000 is working, on the execution screen of the application. For example, the user terminal 6000 may receive information indicating that the portable range hood 3000 is in a non-working state from the wireless power transmission device 1000 via the server 4000, and may display the information indicating that the portable range hood 3000 is in the non-working state (off), on the execution screen of the application.

The user terminal 6000 may receive, from the server 4000, a notification about whether it is required to perform cleaning on the portable range hood 3000. When a notification received from the server 4000 corresponds to a notification indicating that cleaning of the portable range hood 3000 is required, the user terminal 6000 may output a cleaning request notification 6300. The cleaning request notification 6300 may include a message or a voice speech “Cleaning of the portable range hood 3000 is needed”. A user may identify, via the cleaning request notification 6300, that cleaning of the portable range hood 3000 is required.

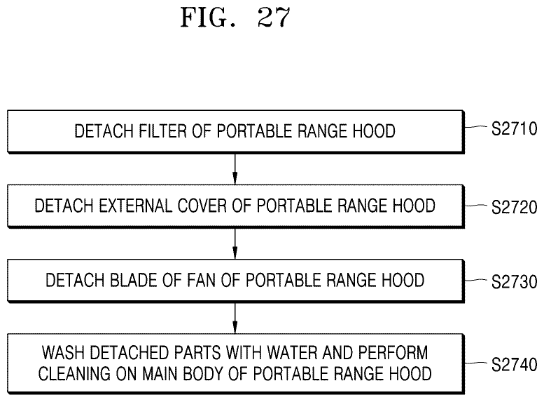

FIG. 27 is a flowchart illustrating a process of detaching and cleaning the portable range hood 3000, according to an example embodiment.

In operation S2710, a user may detach the filter 3600 of the portable range hood 3000. The filter 3600 may be arranged at the inlet or the vent 3900. The filter 3600 may have a structure enabled for attachment and detachment.

In operation S2720, the user may detach an external cover of the portable range hood 3000. For example, the external cover of the portable range hood 3000 is combined using a magnetic member, and thus, may be disassembled into a plurality of parts in detachment.

In operation S2730, the user may detach a blade of the fan 3420 of the portable range hood 3000. The blade of the fan 3420 may have a blade type such as a fan blade of an electric fan. The blade of the fan 3420 may be detached from the shaft 3430.

In operation S2740, the user may wash the detached parts with water, and may perform cleaning on the main body of the portable range hood 3000. The filter 3600, the external cover, and the blade of the fan 3420 which are detached may be washed with water. The main body of the portable range hood 3000 may be cleaned by using cleaning materials such as a cleaning towel, a tissue, a brush, or the like. Accordingly, the user may maintain a clean state of the portable range hood 3000 by conveniently detaching and cleaning the portable range hood 3000.

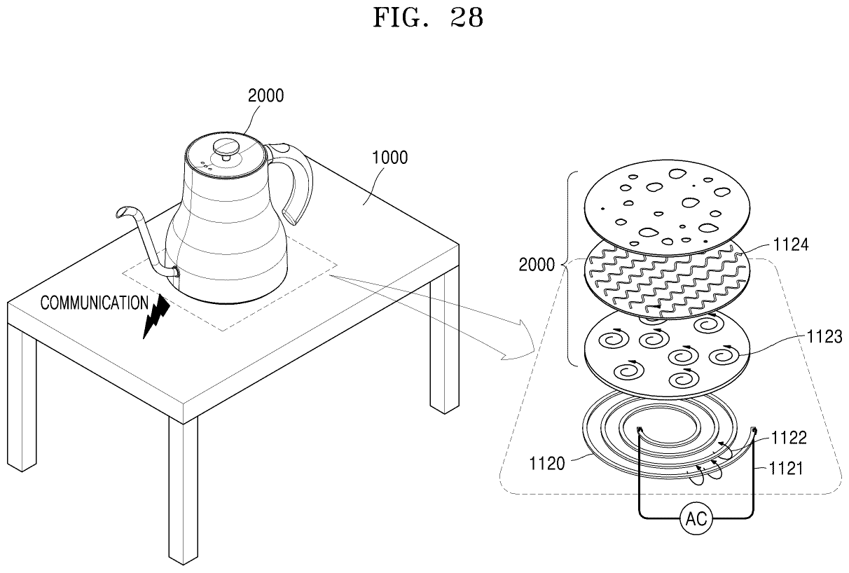

With reference to FIGS. 1 to 27, it is assumed that the wireless power transmission device 1000 is an induction range. However, the present disclosure is not limited thereto, and the wireless power transmission device 1000 may be a smart table that generates an electromagnetic field by using a coil arranged under the table. Hereinafter, a structure of the smart table will now be described in detail with reference to FIG. 28.

FIG. 28 is a diagram illustrating the wireless power transmission device 1000 according to an example embodiment.

In an embodiment, the wireless power transmission device 1000 may be the smart table. The wireless power transmission device 1000 may include the working coil 1120. For example, the wireless power transmission device 1000 may cause an AC current 1121 to flow in the working coil 1120 to generate a magnetic field 1122, and thus may generate an eddy current 1123 in a bottom surface of the cooking appliance 2000. Due to resistance of the eddy current 1123 and an IH metal (e.g., iron), heat is generated in the bottom surface of the cooking appliance 2000. Contents 1124 in the cooking appliance 2000 may be heated up by the generated heat. For example, when the cooking appliance 2000 includes the reception coil 2003 and the load 2004, the wireless power transmission device 1000 may induce a magnetic field in the reception coil 2003, and thus, may transfer power to the load 2004.

According to an example embodiment, the wireless power transmission device 1000 may perform communication with the cooking appliance 2000 via the communication interface 1200. For example, the wireless power transmission device 1000 may transmit or receive information and a limited frequency related to a current operation mode to or from the cooking appliance 2000.

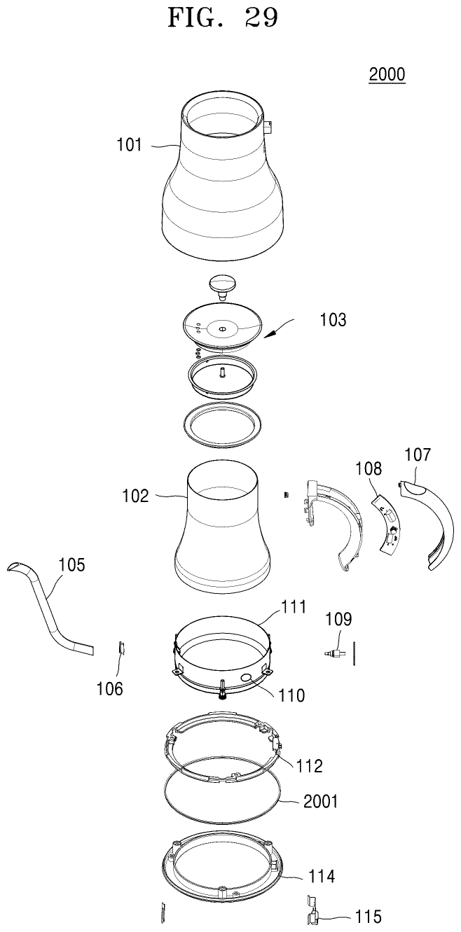

Hereinafter, a structure of a smart kettle will now be described in detail with reference to FIG. 29.

FIG. 29 is a diagram illustrating the cooking appliance 2000 according to an example embodiment. The cooking appliance 2000 of FIG. 29 may be the induction heating load device 2000-1.

The cooking appliance 2000 according to an embodiment may include an outer container 101, an inner container 102, a lid 103, a water tank 104, a spout 105, a spout guide 106, a handle 107, a PCB 108, a water temperature sensor 109, an outer container temperature sensor 110, a case cover 111, a pickup coil cover 112, a pickup coil 2001, a bottom case 114, and a silicone leg 115. However, the present disclosure is not limited thereto, and the cooking appliance 2000 may further include elements required to form the smart kettle.

The outer container 101 may be arranged to surround a lateral surface portion of the inner container 102. The inner container 102 may be composed of an upper portion and a lower portion, and the upper portion of the inner container 102 may include a material different from a material used to form the lower portion of the inner container 102. For example, the upper portion of the inner container 102 may include a non-magnetic material, and the lower portion of the inner container 102 may include a magnetic material.

The lid 103 may be attached to and detached from the inner container 102. While the kettle 1000a operates in a heat retention mode, when the lid 103 covers the inner container 102, a temperature of contents may decrease slowly, and, when the lid 103 does not cover the inner container 102, the temperature of the contents may decrease quickly.

The water tank 104 may be a space for accommodating contents.

The spout 105 may be a pipe for flowing contents in the water tank 104 to the outside. The spout 105 may be connected to the water tank 104 via at least the spout guide 106, and may be exposed to the outside via the outer container 101.

The handle 107 may be attached to the outer container 101. The handle 107 may include a waterproof member to prevent water from penetrating into the handle 107. The PCB 108 may be arranged in the handle 107.

The PCB 108 may correspond to the PCB 2005 of FIGS. 8 and 9. The PCB 1008 may include a power module, a controller, and a communication interface. For example, the PCB 108 may include an output interface (e.g., a buzzer).

An electric line connected from the PCB 108 may be connected to the water temperature sensor 109, the outer container temperature sensor 110, and the pickup coil 2001 via a space between the outer container 101 and the inner container 102. As the electric line may be in contact with the inner container 102 of a high temperature, the electric line may be surrounded by a heat-resistant glass fiber. When the electric line connected from the PCB 108 is connected via the space between the outer container 101 and the inner container 102, an instrument guide (e.g., a holder) protruding from the outer container 101 may be closely fixed to the outer container 101 in order to minimize a contact between the electric line and the inner container 102.

The water temperature sensor 109 may be arranged while passing through the inner container 102. The water temperature sensor 109 may be arranged to pass through the inner container 102 in parallel to a bottom surface, or may be arranged to pass through the inner container 102 at an angle toward the lower surface. The water temperature sensor 109 may be in contact with contents (e.g., water) in the water tank 104. The water temperature sensor 109 may measure a temperature of contents. The outer container temperature sensor 110 is configured to measure a temperature of the outer container 101, and may be arranged on a lateral surface of the lower portion of the inner container 102. The outer container temperature sensor 110 may be arranged to be lower than the water temperature sensor 109, but the present disclosure is not limited thereto. According to an example embodiment, a plurality of outer container temperature sensors 110 may be arranged in a circumferential direction of the inner container 102.

The pickup coil cover 112 may be arranged to surround the pickup coil 2001. The pickup coil 2001 may be arranged between the inner container 102 and the outer container 101. The pickup coil 2001 may be arranged to surround the lower portion of the inner container 102. The pickup coil 2001 may be arranged between the outer container temperature sensor 110 and the outer container 101. The pickup coil 2001 may correspond to the working coil 1120 of FIG. 9.

The bottom case 114 may include a material that is prone to generate an eddy current that rotates about an electromagnetic field formed by the wireless power transmission device 1000.

The silicone leg 115 may be arranged in a lower portion of the bottom case 114. The silicone leg 115 may be a component for relieving impact when the cooking appliance 2000 is placed on a top plate of the wireless power transmission device 1000 and preventing the cooking appliance 2000 from slipping.

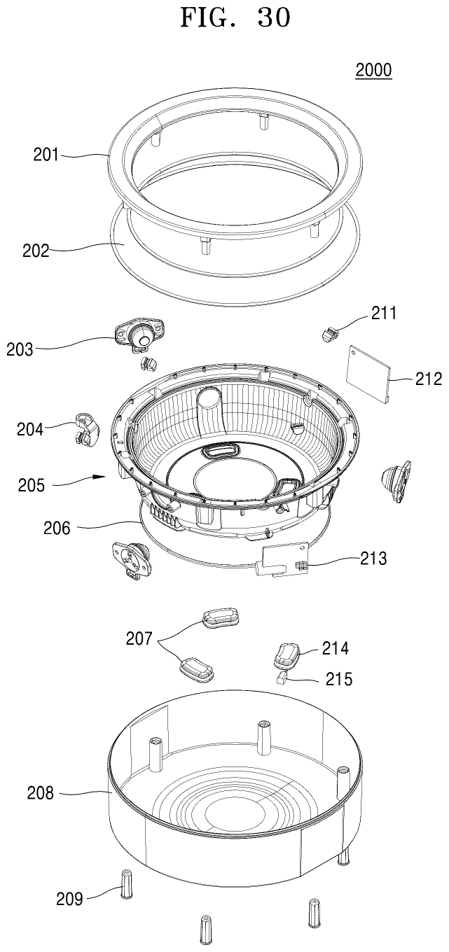

According to an example embodiment, the cooking appliance 2000 may wirelessly receive power from the wireless power transmission device 1000 via the pickup coil 2001 so as to drive the communication interface included in the PCB 108 in the handle 107. The cooking appliance 2000 may perform short-range wireless communication with the wireless power transmission device 1000 via the communication interface. For example, the cooking appliance 2000 may transmit information about the amount of received power to the wireless power transmission device 1000. For example, the cooking appliance 2000 may transmit temperature information about a temperature of the contents to the wireless power transmission device 1000. Hereinafter, with reference to FIG. 30, a structure of a smart pot will now be described in detail.

FIG. 30 is a diagram illustrating the cooking appliance 2000 according to an example embodiment. The cooking appliance 2000 of FIG. 30 may be the induction heating load device 2000-1. The cooking appliance 200 according to embodiment may include a top cover 201, inner/outer sealing 202, a side sensor assembly module 203, a buzzer assembly module 204, an inner case 205, a pickup coil 206, rubber legs 207, a body 208, a screw cover 209, a guide rubber 211, a BLE PBA module 212, a power PBA module 213, a sensor leg 214, and a bottom sensor 215. However, the present disclosure is not limited thereto, and the cooking appliance 2000 may further include elements for forming the smart pot.

The top cover 201 may form an outer appearance of the cooking appliance 2000. The top cover 201 may seat the cooking container including contents.

The inner/outer sealing 202 may be compressed during assembly of the cooking appliance 2000 to block a moisture infiltration path. The inner/outer sealing 202 may enhance water resistance of the cooking appliance 2000.

The side sensor assembly module 203 may include a side temperature sensor for measuring a temperature of the cooking container, a fixing member for fixing the side temperature sensor, and an elastic member (e.g., a spring) that is compressed and deformed when the cooking container is seated. However, the present disclosure is not limited thereto, and the side sensor assembly module 203 may include sensors configured to measure environmental factors that the cooking appliance 2000 attempts to measure. The elastic member of the side sensor assembly module 203 may be compressed and deformed as the cooking container is accommodated in an internal space of the cooking appliance 2000. For example, when the cooking container is not seated in the cooking appliance 2000, the side sensor assembly module 203 protrudes inward, and, as the cooking container is seated in the cooking appliance 2000, the side sensor assembly module 203 may be pressed. In this case, as a size of the cooking container increases, a compression rate of the side sensor assembly module 203 may increase. Therefore, the cooking appliance 2000 according to an example embodiment may accommodate various sizes of the cooking container.

According to an example embodiment, the side sensor assembly module 203 including a side temperature sensor may be disposed at a predetermined height or more apart from the bottom surface of the cooking appliance 2000. As the side temperature sensor is also an electrical element, the side sensor assembly module may be affected by induction heating of the wireless power transmission device 1000. Therefore, in order to minimize an influence of induction heating of the wireless power transmission device 1000 (e.g., overheating of the side temperature sensor itself and noise occurrence due to induction heating), the side sensor assembly module 203 may be disposed a preset height or more from the bottom surface of the cooking appliance 2000. For example, in order to increase the accuracy of temperature data of the cooking container, the side sensor assembly module 203 including a side temperature sensor may be disposed at a height that meets a straight surface of the cooking container rather than an inclined surface of the cooking container.

According to an example embodiment, the side sensor assembly module 203 including a side temperature sensor may be provided in plural in the cooking appliance 2000 so as to prevent eccentricity (e.g., the cooking container is seated biased to one side) due to a difference between sizes of the cooking container. For example, three side sensor modules 203 may be arranged at 120° angular intervals in an inner circumferential direction of the cooking appliance 2000.

The buzzer assembly module 204 may be configured to output a notification signal in abnormal heating of the cooking container. The inner case 205 may support the cooking container. The inner case 205 may include the side sensor assembly module 203, the pickup coil 206, the BLE PBA module 212, and the power PBA module 213.

The pickup coil 206 may wirelessly receive power from the wireless power transmission device 1000. For example, the pickup coil 206 may be a low-power coil that generates power for operating the BLE PBA module 212. The pickup coil 206 may be an element that corresponds to the pickup coil 2001 of FIG. 9.

The rubber legs 207 may alleviate an impact between the cooking container and the cooking appliance 2000 when the cooking container is seated in the cooking appliance 2000. The rubber legs 207 may prevent the cooking container from slipping.

The body 208 may serve to form the outer appearance of the cooking appliance 2000 and cover the internals thereof. The body 208 may prevent heat conduction to the outside during a cooking operation. According to an example embodiment, the body 208 may include a part (handle part) that a user holds together with the cooking container seated in the cooking appliance 2000 when the cooking appliance 2000 is moved.

The screw cover 209 may cover a screw. The screw cover 209 may alleviate the impact of the cooking appliance 2000 when the cooking appliance 2000 is placed on the wireless power transmission device 1000. The screw cover 209 may prevent the cooking appliance 2000 from slipping.

The guide rubber 211 may prevent eccentricity when the cooking container is seated in the cooking appliance 2000. The guide rubber 211 may alleviate the impact of the cooking container. The guide rubber 211 may prevent the cooking container 10 from slipping

The BLE PBA module 212 may include a communication interface and a controller. The BLE PBA module 212 may perform wireless communication (e.g., BLE communication) with the wireless power transmission device 1000. The BLE PBA module 212 may control an output (e.g., a power level value) of the wireless power transmission device 1000. For example, the BLE PBA module 212 may include a microcontroller unit (MCU). The MCU may receive an input of temperature data from the cooking container. The MCU may store an algorithm or recipe information for automatic cooking.

The power PBA module 213 may convert the power received from the pickup coil 206 into a use voltage of the BLE PBA module 212. For example, the power PBA module 213 may be a power converter configured to receive AC power from the pickup coil 206 and then to supply DC power to the MCU or a BLE module included in the BLE PBA module 212. The power PBA module 213 may correspond to the power module 2010 of FIG. 3.

The sensor leg 214 may be an element to which the bottom sensor 215 is assembled, among the rubber legs 207. As the sensor leg 214 is a type of rubber leg 207, the sensor leg 214 may alleviate the impact between the cooking container and the cooking appliance 2000 and prevent the cooking container from slipping, when the cooking container is seated in the cooking appliance 2000.

The bottom sensor 215 may be a temperature sensor configured to detect abnormal overheating of the cooking container. The bottom sensor 215 may be arranged at a different position from the side sensor assembly module 203 including a side temperature sensor for measuring a temperature of the cooking container. For example, the bottom sensor 215 may be arranged on the bottom surface of the cooking appliance 2000, and three side sensor modules 203 may be arranged on the lateral side of the cooking appliance 2000. According to an example embodiment, when abnormal overheating occurs in the cooking container, a temperature of the bottom surface of the cooking container rises most rapidly, and thus the bottom sensor 215 may be assembled to the sensor leg 214, which is one of the rubber legs 207, so that abnormal overheating of the cooking container may be quickly detected.

According to an example embodiment, the cooking appliance 2000 may wirelessly receive power from the wireless power transmission device 1000 via the pickup coil 206 so as to drive the communication interface included in the BLE PBA module 212. The cooking appliance 2000 may perform short-range wireless communication with the wireless power transmission device 1000 via the communication interface. For example, the cooking appliance 2000 may transmit information about the amount of received power to the wireless power transmission device 1000. For example, the cooking appliance 2000 may transmit temperature information about a temperature of the contents to the wireless power transmission device 1000.

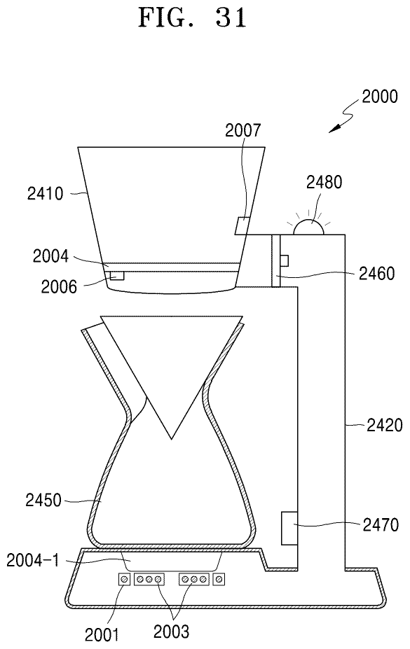

Hereinafter, a structure of a coffee dripper will now be described in detail with reference to FIG. 31.

FIG. 31 is a diagram illustrating the cooking appliance 2000 according to an example embodiment. The cooking appliance 2000 of FIG. 31 may be the induced voltage load device 2000-2.

In an embodiment, the cooking appliance 2000 may include a water heating part 2410 for heating up water, at an upper portion thereof, and a coffee accommodation part 2450 for accommodating dripped coffee, at a lower portion thereof. The water heating part 2410 may include a heater 2004 (corresponding to the load 2004 in FIG. 3), and a first temperature sensor 2006 and a second temperature sensor 2007 for measuring a temperature in the water heating part 2410.

In an embodiment, the coffee accommodation part 2450 may include the pickup coil 2001, the reception coil 2003, and an accommodation part heater 2004-1. The coffee accommodation part 2450 may be formed of borosilicate, but the present disclosure is not limited thereto. The reception coil 2003 of the coffee accommodation part 2450 may be electrically connected to the reception coil 2003 included in the water heating part 2410 via at least a connection part 2420. The reception coil 2003 and the accommodation part heater 2004-1 may be used to warm and heat up accommodated coffee. The reception coil 2003 may be formed of a heat-resistant wire. The connection part 2420 may connect the coffee accommodation part 2450 to the water heating part 2410. The connection part 2420 may include a detection sensor 2470, a solenoid valve 2460, and a light emitting part 2480.

The detection sensor 2470 may determine whether the coffee accommodation part 2450 is located at an upper portion. The detection sensor 2470 may be a Time of Flight (ToF) sensor. The solenoid valve 2460 may allow water to flow by opening and closing a valve according to a control signal, and thus, may fill water in the water heating part 2410. The solenoid valve 2460 may be a direct-acting type solenoid valve. The light emitting part 2480 may emit light during an operation of the cooking appliance 2000, and thus, may display that it is operating.

According to an example embodiment, a portable range hood 3000 may include a wireless power receiver 3100 configured to receive power from a wireless power transmission device 1000 including a plurality of cooking zones, a communication interface 3200 configured to establish wireless communication connection to the wireless power transmission device 1000 or a cooking appliance 2000 placed on the wireless power transmission device 1000, a driving unit 3400 configured to receive the power and perform a draw-in operation for drawing in air into the portable range hood 3000, at least one filter 3600 configured to filter out oil vapor and odors included in the air, and at least one processor 3700. The at least one processor 3700 may be configured to, based on the wireless power receiver 3100 being located in a first cooking zone from among the plurality of cooking zones, receive power from the wireless power transmission device 1000, and activate the communication interface 3200. The at least one processor 3700 may be configured to control the communication interface 3200 to receive, from the wireless power transmission device 1000, an operation command generated based on state information of the cooking appliance 2000 located in a second cooking zone from among the plurality of cooking zones. The at least one processor 3700 may be configured to control the driving unit 3400 to set at least one of whether to perform the draw-in operation, a strength of the draw-in operation, and a duration time of the draw-in operation, based on the operation command.

In an embodiment, the operation command includes information related to a strength of the draw-in operation, and the strength of the draw-in operation is determined based on temperature information of the cooking appliance 2000 or whether the cooking appliance 2000 is displaced from the second cooking zone.

In an embodiment, the at least one processor 3700 may be configured to control the driving unit 3400 to increase the strength of the draw-in operation, based on an exhaust increase command included in the operation command. The at least one processor 3700 may be configured to control the driving unit 3400 to decrease the strength of the draw-in operation, based on an exhaust decrease command included in the operation command.

In an embodiment, the at least one processor 3700 may be configured to control the driving unit 3400 to stop the draw-in operation when cooking by the cooking appliance 2000 is completed or after an elapse of a preset time.

In an embodiment, the at least one processor 3700 may be configured to control the communication interface 3200 to receive recipe information from the wireless power transmission device 1000. The at least one processor 3700 may be configured to control the driving unit 3400 to set at least one of whether to perform the draw-in operation, the strength of the draw-in operation, and the duration time of the draw-in operation, based on the recipe information.

In an embodiment, the wireless power receiver 3100 may include a reception coil 3110 configured to wirelessly receive the power from the wireless power transmission device 1000. The wireless power receiver 3100 may be arranged at a bottom surface of the portable range hood 3000, or may be arranged to be close to the bottom surface of the portable range hood 3000.

In an embodiment, the driving unit 3400 may include a motor 3410, a shaft 3430 forming a rotation shaft of the motor 3410, and a fan 3420 configured to rotate by being connected, directly or indirectly, to the shaft 3430. The air flowing into the portable range hood 3000 during the draw-in operation may be introduced from a first direction which the shaft 3430 faces.

In an embodiment, the at least one filter 3600 may include a first filter 3610 configured to filter out oil vapor included in the air, and a second filter 3620 configured to filter out odors included in air having passed through the first filter.

In an embodiment, the first filter 3610 may be arranged at an inlet via which the air is drawn in during the draw-in operation or is arranged at a lower part of a vent 3900. The second filter 3620 may be arranged at an upper part of the vent 3900.

In an embodiment, the state information may include at least one of location information of the second cooking zone in which the cooking appliance 2000 is placed, temperature information of the cooking appliance 2000 or the second cooking zone, and height information of the cooking appliance 2000.

In an embodiment, the portable range hood 3000 may include a support part capable of adjusting at least one of a draw-in direction of the portable range hood 3000 and a first height of the portable range hood 3000. The at least one processor 3700 may be configured to control the support part to adjust at least one of the draw-in direction and the first height, based on the operation command.

In an embodiment, the at least one processor 3700 may be configured to obtain, based on the state information, a second height of the cooking appliance 2000 and a location of the second cooking zone in which the cooking appliance 2000 is arranged. The at least one processor 3700 may be configured to rotate the portable range hood 3000 to have the draw-in direction and the first height, based on the second height and the location. The at least one processor 3700 may be configured to perform the draw-in operation in the draw-in direction and at the first height which are set after the rotating.

In an embodiment, the at least one processor 3700 may be configured to control the communication interface 3200 to receive, from the wireless power transmission device 1000, a first mode entry command generated based on opening information indicating that a lid of the cooking appliance 2000 is open. The at least one processor 3700 may be configured to increase a rotation speed of the motor 3410 of the driving unit 3400 by entering a first mode based on the first mode entry command. The at least one processor 3700 may be configured to control the communication interface 3200 to receive, from the wireless power transmission device 1000, a second mode entry command generated based on closing information indicating that the lid of the cooking appliance 2000 is closed. The at least one processor 3700 may be configured to decrease a rotation speed of the motor 3410 by entering a second mode based on the second mode entry command.

According to an example embodiment, a method of controlling a portable range hood 3000 may include, based on a wireless power receiver 3100 of the portable range hood 3000 being located in a first cooking zone from among a plurality of cooking zones included in a wireless power transmission device 1000, receiving power from the wireless power transmission device 1000, and activating a communication interface 3200 of the portable range hood 3000. The method of controlling the portable range hood 3000 may include receiving, from the wireless power transmission device 1000, an operation command generated based on state information of a cooking appliance 2000 located in a second cooking zone from among the plurality of cooking zones. The method of controlling the portable range hood 3000 may include setting, based on the operation command, at least one of whether to perform a draw-in operation for drawing in air into the portable range hood 3000, a strength of the draw-in operation, and a duration time of the draw-in operation.

In an embodiment, the method of controlling the portable range hood 3000 may include increasing the strength of the draw-in operation, based on an exhaust increase command included in the operation command. The method of controlling the portable range hood 3000 may include decreasing the strength of the draw-in operation, based on an exhaust decrease command included in the operation command.

In an embodiment, the control method of the portable range hood 3000 may include stopping the draw-in operation when cooking by the cooking appliance 2000 is completed or a preset time is elapsed.

In an embodiment, the control method of the portable range hood 3000 may include controlling the communication interface 1200 to receive recipe information from the wireless power transmission device 1000. The control method of the portable range hood 3000 may include controlling the driving unit 3400 to set at least one of whether to perform the draw-in operation, a strength of the draw-in operation, and a duration time of the draw-in operation, based on the recipe information.

In an embodiment, the control method of the portable range hood 3000 may include controlling the support part of the portable range hood 3000 so as to adjust at least one of a draw-in direction of the draw-in operation and a first height of the draw-in operation, based on an operation command.

In an embodiment, the control method of the portable range hood 3000 may include obtaining, based on state information, a second height of the cooking appliance 2000 and a location of a second cooking zone in which the cooking appliance 2000 is arranged. The control method of the portable range hood 3000 may include rotating the portable range hood 3000 to have a draw-in direction and a first height, based on the second height and the location. The control method of the portable range hood 3000 may include performing the draw-in operation in the draw-in direction and at the first height which are set after rotation.

According to an example embodiment, the wireless power transmission device 1000 may include a plurality of cooking zones, the wireless power transmitter 1100, the communication interface 1200, and the at least one processor 1400. The at least one processor 1400 may be configured to establish wireless communication connection by transmitting power to the portable range hood 3000 located in a first cooking zone from among the plurality of cooking zones. The at least one processor 1400 may be configured to control the communication interface 1200 to receive state information of the cooking appliance 2000 located in a second cooking zone from among the plurality of cooking zones. The at least one processor 1400 may be configured to generate an operation command for the portable range hood 3000, based on the state information of the cooking appliance 2000. The at least one processor 1400 may be configured to control the communication interface 1200 to transmit the operation command for the portable range hood 3000 to the portable range hood 3000.

According to the present disclosure, provided are a portable range hood capable of efficiently removing oil vapor and odors which occur from a cooking appliance located on a wireless power transmission device, and a control method of the portable range hood according to a state of the cooking appliance.

A method according to an example embodiment may be embodied as program commands executable by various computer devices, and recorded on a computer-readable medium. The computer-readable medium may include program commands, data files, data structures, or the like separately or in combinations. The program commands to be recorded on the medium may be specially designed and configured for the present disclosure or may be well-known to and be usable by one of skill in the art of computer software. Examples of the computer-readable recording medium include magnetic media such as hard disks, floppy disks, or magnetic tapes, optical media such as a compact disc read-only memory (CD-ROM) or a digital video disc (DVD), magneto-optical media such as a floptical disk, and hardware devices such as read-only memory (ROM), random-access memory (RAM), or flash memory, which are specially configured to store and execute program commands. Examples of the program commands include not only machine code, such as code made by a compiler, but also high-level language code that is executable by a computer by using an interpreter or the like.

Some embodiments of the present disclosure may be implemented as a recording medium including computer-readable instructions such as a computer-executable program module. The computer-readable medium may be any available medium which is accessible by a computer, and may include a volatile or non-volatile medium and a removable or non-removable medium. Also, the computer-readable medium may include a computer storage medium and a communication medium. The computer storage media include both volatile and non-volatile, removable and non-removable media implemented in any method or technique for storing information such as computer-readable instructions, data structures, program modules or other data. The communication media typically include computer-readable instructions, data structures, program modules, other data of a modulated data signal, or other transmission mechanisms, and examples thereof include an arbitrary information transmission medium. Also, some embodiments of the present disclosure may be implemented as a computer program or a computer program product including computer-executable instructions such as a computer program executed by a computer.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment, methods according to various embodiments disclosed in the present specification may be included in a computer program product and then provided. The computer program product may be traded as commodities between sellers and buyers. The computer program product may be distributed in the form of a machine-readable storage medium (e.g., a compact disc read only memory (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

1. A portable range hood comprising:
a wireless power receiver configured to receive power from a wireless power transmission device comprising a plurality of cooking zones;
a communication interface, comprising circuitry, configured to establish wireless communication connection to the wireless power transmission device and/or a cooking appliance placed on the wireless power transmission device;
a driving unit, comprising a motor and/or a fan, configured to receive the power and perform a draw-in operation for drawing air into the portable range hood;
at least one filter configured to filter out oil vapor and odors comprised in the air; and
at least one processor, comprising processing circuitry, individually and/or collectively configured to:
based on the wireless power receiver being located in a first cooking zone from among the plurality of cooking zones, receive power from the wireless power transmission device, and activate the communication interface;
control the communication interface to receive, from the wireless power transmission device, an operation command generated based on state information of the cooking appliance located in a second cooking zone from among the plurality of cooking zones; and
control the driving unit to set at least one of whether to perform the draw-in operation, a strength of the draw-in operation, and a duration time of the draw-in operation, based on the operation command.

2. The portable range hood of claim 1, wherein
the operation command comprises information related to the strength of the draw-in operation, and
the strength of the draw-in operation is based on temperature information of the cooking appliance and/or whether the cooking appliance is displaced from the second cooking zone.

3. The portable range hood of claim 1, wherein the at least one processor is further configured to:
control the driving unit to increase the strength of the draw-in operation, based on an exhaust increase command comprised in the operation command; and
control the driving unit to decrease the strength of the draw-in operation, based on an exhaust decrease command comprised in the operation command.

4. The portable range hood of claim 1, wherein the at least one processor is further configured to control the driving unit to stop the draw-in operation when cooking by the cooking appliance is completed and/or after an elapse of a preset time.

5. The portable range hood of claim 1, wherein the at least one processor is further configured to:
control the communication interface to receive recipe information from the wireless power transmission device; and
control the driving unit to set at least one of whether to perform the draw-in operation, the strength of the draw-in operation, and the duration time of the draw-in operation, further based on the recipe information.

6. The portable range hood of claim 1, wherein the wireless power receiver comprises a reception coil configured to wirelessly receive the power from the wireless power transmission device, and
is arranged at a bottom surface of the portable range hood, and/or is arranged to be close to the bottom surface of the portable range hood.

7. The portable range hood of claim 1, wherein the driving unit comprises:
a motor;
a shaft forming a rotation shaft of the motor; and
a fan configured to rotate by being connected to the shaft, and
the driving unit is configured so that the air flowing into the portable range hood during the draw-in operation is introduced from a first direction which the shaft faces.

8. The portable range hood of claim 1, wherein the at least one filter comprises:
a first filter configured to filter out oil vapor comprised in the air; and
a second filter configured to filter out odors comprised in air having passed through the first filter.

9. The portable range hood of claim 8, wherein
the first filter is arranged at an inlet via which the air is drawn in during the draw-in operation or is arranged at a lower part of a vent, and
the second filter is arranged at an upper part of the vent.

10. The portable range hood of claim 1, wherein the state information comprises at least one of location information of the second cooking zone in which the cooking appliance is placed, temperature information of the cooking appliance or the second cooking zone, and height information of the cooking appliance.

11. The portable range hood of claim 1, further comprising
a support part configured for adjusting at least one of a draw-in direction of the portable range hood and a first height of the portable range hood, and
wherein the at least one processor is further configured to
control the support part to adjust at least one of the draw-in direction and the first height, based on the operation command.

12. The portable range hood of claim 11, wherein the at least one processor is further configured to:
obtain, based on the state information, a second height of the cooking appliance and a location of the second cooking zone in which the cooking appliance is arranged;
rotate the portable range hood to have the draw-in direction and the first height, based on the second height and the location; and
perform the draw-in operation in the draw-in direction and at the first height which are set after the rotating.

13. The portable range hood of claim 1, wherein the at least one processor is further configured to:
control the communication interface to receive, from the wireless power transmission device, a first mode entry command generated based on opening information indicating that a lid of the cooking appliance is open;
increase a rotation speed of the motor of the driving unit at least by entering a first mode based on the first mode entry command;
control the communication interface to receive, from the wireless power transmission device, a second mode entry command generated based on closing information indicating that the lid of the cooking appliance is closed; and
decrease the rotation speed of the motor at least by entering a second mode based on the second mode entry command.

14. A method of controlling a portable range hood, the method comprising:
based on a wireless power receiver of the portable range hood being located in a first cooking zone from among a plurality of cooking zones comprised in a wireless power transmission device, receiving power from the wireless power transmission device, and activating a communication interface of the portable range hood;
receiving, from the wireless power transmission device, an operation command generated based on state information of a cooking appliance located in a second cooking zone from among the plurality of cooking zones; and
setting, based on the operation command, at least one of whether to perform a draw-in operation for drawing in air into the portable range hood, a strength of the draw-in operation, and a duration time of the draw-in operation.

15. The method of claim 14, further comprising:
increasing the strength of the draw-in operation, based on an exhaust increase command comprised in the operation command; and
decreasing the strength of the draw-in operation, based on an exhaust decrease command comprised in the operation command.
